(19) United States
(12) Patent Application Publication
(10) Pub. No.: US 2013/0176283 A1
(43) Pub. Date: Jul. 11, 2013

(54) ELECTRONIC APPARATUS, AND METHOD OF OPERATING ELECTRONIC APPARATUS

(71) Applicant: SONY CORPORATION, Tokyo (JP)

(72) Inventor: Masashi Nakata, Kanagawa (JP)

(73) Assignee: SONY CORPORATION, Tokyo (JP)

(21) Appl. No.: 13/673,511

(22) Filed: Nov. 9, 2012

(30) Foreign Application Priority Data
Dec. 5, 2011 (JP) 2011-265436

(51) Int. Cl. G06F 3/042

(52) U.S. Cl. CPC G06F 3/042
USPC 345/175

(57) ABSTRACT

An electronic apparatus includes: a display unit; an identification unit that optically identifies a kind of an operator positioned on a display face of the display unit; and a control unit that controls content of an operation for the display unit according to the kind of the operator identified by the identification unit.

### BACKGROUND

The present disclosure relates to an electronic apparatus and a method of operating the electronic apparatus, and more particularly, to an electronic apparatus provided with a display unit, and a method of operating the electronic apparatus.

An electronic apparatus provided with a display unit, for example, a mobile phone, a mobile information terminal such as a PDA (Personal Digital Assistant), an ATM (Automatic Teller Machine) provided in a bank and the like, and a ticket vending machine provided in a station and the like, uses a touch panel instead of an operation unit including operation buttons, to improve operability.

Classifying the touch panels from the viewpoint of an operator, as the touch panels, there is a touch panel (for example, Japanese Unexamined Patent Application Publication No. 2010-26710) operated by a finger, and there is a touch panel (for example, Japanese Unexamined Patent Application Publication No. 2008-98763) operated using a dedicated operator such as a touch pen.

### SUMMARY

Even in the different types of touch panels described above, merely a position on a screen to which an operator, such as a finger and a touch pen, makes contact is detected, and there is difficulty with the variety of operations. On the other hand, when the kind of the operating operator is optically identified and it is possible to control the content of the operation for the display unit according to the kind of the identified operator, the operation becomes various, and it is possible to further improve the operability.

It is desirable to provide an electronic apparatus and a method of operating the electronic apparatus capable of further improving operability by employing a touch panel type.

According to an embodiment of the present disclosure, there is provided an electronic apparatus including a display unit; an identification unit that optically identifies a kind of an operator positioned on a display face of the display unit; and a control unit that controls content of an operation for the display unit according to the kind of the operator identified by the identification unit.

According to another embodiment of the present disclosure, there is provided a method of operating an electronic apparatus provided with a display unit, the method including optically identifying a kind of an operator positioned on a display face of the display unit; and controlling a content of an operation for the display unit according to the identified kind of the operator.

In the electronic apparatus or the method of operating the same according to the embodiment of the present disclosure, the kind of the operator positioned on the display face of the display unit is optically identified, and thus it is possible to more reliably identify the kind of the operator. In addition, the operation content for the display unit is controlled according to the identification result, and thus it is possible to switch the operation content to desired content in the course of the operation based on the operator.

According to the embodiments of the present disclosure, the position information of the display face of the operated operator is acquired, the operation content for the display unit is switchable according to the kind of the operator in the course of the operation based on the operator, and thus it is possible to further improve operability.

### BRIEF DESCRIPTION OF THE DRAWINGS

FIG. 1 is a perspective view illustrating a schematic appearance of a portable music player according to embodiments of the present disclosure.

FIG. 2 is a plan view illustrating an example of layout of light emitting elements and light receiving elements in a display unit according to Example 1.

FIG. 3 is a cross-sectional view taken along the line III-III of FIG. 2.

FIG. 4 is a block diagram illustrating an example of a configuration of a control system according to Example 1.

FIG. 5 is a flowchart illustrating a process sequence performed under a control of the control system according to Example 1.

FIG. 6A is a diagram illustrating an example of an output spectrum of an organic EL element and sensitivity characteristics of a photodiode, and FIG. 6B is a diagram illustrating an example of reflectance of a nail and skin.

FIG. 7A is a diagram illustrating an example of output when skin is irradiated with light, and FIG. 7B is a diagram illustrating an example of output when a nail is irradiated with light.

FIG. 8A and FIG. 8B are diagrams illustrating specific examples of operation contents for the display unit, FIG. 8A is a diagram illustrating a case of skin touch, and FIG. 8B is a diagram illustrating a case of nail touch.

FIG. 9A and FIG. 9B are diagrams illustrating examples of use in a music player, and FIG. 9A is a diagram illustrating an operation example of skin and FIG. 9B is a diagram illustrating an operation example of a nail.

FIG. 10A and FIG. 10B are diagrams illustrating examples of use in painting software, FIG. 10A is a diagram illustrating solid line drawing, and FIG. 10B is a diagram illustrating a case of broken line drawing.

FIG. 11 is a cross-sectional view illustrating another example 1 of layout of light emitting elements and light receiving elements.

FIG. 12A to FIG. 12C are a cross-sectional view illustrating another example 2 of layout of light emitting elements and light receiving elements.

FIG. 13 is a plan view illustrating another example 3 of layout of light emitting elements and light receiving elements.

FIG. 14 is a plan view illustrating another example 4 of layout of light emitting elements and light receiving elements.

FIG. 15 is a schematic perspective view illustrating an example of a configuration around a display unit according to Example 2.

FIG. 16 is a block diagram illustrating an example of a configuration of a control system according to Example 2.

FIG. 17 is a front view illustrating an example of a ballpoint type touch pen according to Example 3.

FIG. 18A to FIG. 18C are diagrams illustrating specific examples of operation contents for a display unit in a case of Example 3.

FIG. 19A to FIG. 19D are diagrams illustrating examples of a work in a touch penal type electronic apparatus of the related art.

FIG. 20A and FIG. 20B are diagrams illustrating example of a work in a case of Example 3.

FIG. 21 is a schematic perspective view illustrating an example of a configuration around a display unit according to Example 4.

FIG. 22 is a manufacturing process diagram illustrating an example of a method of manufacturing a display unit according to the embodiment.

FIG. 23A and FIG. 23B are diagrams illustrating an effect to reflectance measurement of direct light from an organic EL element.

FIG. 24 is a manufacturing process diagram (first) illustrating another example of a method of manufacturing a display unit according to the embodiment.

FIG. 25 is a manufacturing process diagram (second) illustrating another example of a method of manufacturing a display unit according to the embodiment.

### DETAILED DESCRIPTION OF EMBODIMENTS

Hereinafter, embodiment for describing the present disclosure will be described in detail with reference to the drawings. The present disclosure is not limited to the embodiments, and various conditions and numerical values in the embodiments are examples. In the following description, the same reference numerals and signs are used for the same elements or elements having the same functions, and the overlapped description is omitted. The description is performed in the following order.

### 1. Overall Description of Electronic Apparatus and Method of Operating Electronic Apparatus of Present Disclosure

2. Electronic Apparatus according to Embodiment

### 2-1. Example 1

### 2-2. Example 2

### 2-3. Example 3

### 2-4. Example 4

### 2-5. Manufacturing Method

### 3. Modification Example

### 4. Configuration of Present Disclosure

### 1. Overall Description of Electronic Apparatus and Method of Operating Electronic Apparatus of Present Disclosure

An electronic apparatus according to an embodiment of the present disclosure is an electronic apparatus provided with a display unit. The electronic apparatus provided with the display unit may be, for example, a mobile information terminal such as a personal computer (PC), a mobile phone, a PDA (Personal Digital Assistant), a music player, a tablet PC, a games console, or an electronic book apparatus. The present disclosure is not limited to the mobile information terminals, and the electronic apparatus provided with the display unit may be, for example, an ATM (Automatic Teller Machine), provided in a bank, a ticket vending machine provided in a station, and the like.

The display unit of the electronic apparatus according to the embodiment of the present disclosure may be a display unit corresponding to black display, and may be a display unit corresponding to color display. In a case of corresponding to the color display, one pixel (a unit pixel) that is a unit of forming a color image is formed of a plurality of sub-pixels. More specifically, in the display unit corresponding to the color display, one pixel is formed of, for example, three sub-pixels of a sub-pixel displaying red (R), a sub-pixel displaying green (G), and a sub-pixel displaying blue (B).

However, one pixel is not limited to the combination of sub-pixels of three primary colors of RGB, and one pixel may be formed by adding one or more colors to the sub-pixels of three primary colors of RGB. More specifically, for example, one pixel may be formed by adding a sub-pixel displaying white (W) to improve brightness, and one pixel may be formed by adding at least one pixel displaying a complementary color to expand a color reproduction range.

The electronic apparatus according to the embodiment of the present disclosure has a configuration capable of performing various operations on a display face of the display unit. For the operation on the display face, the electronic apparatus according to the embodiment of the present disclosure is provided with an identification unit that optically identifies a kind of an operator positioned on the display face of the display unit, and a control unit that controls a content of an operation for the display unit according to the kind of the operator identified by the identification unit.

Herein, the “operator” is an object used when a user of the electronic apparatus performs an operation on the display face. When the user of the electronic apparatus performs the operation with a finger, the finger is the operator. In the operation based on the finger, a case of operating with a nail part, a case of operating with a skin part such as a ball of the finger (the inside of the finger), and a case of operating with a boundary part between the nail and the skin on the lateral side of the finger may be conceivable.

Fingers of a human are different in reflectance according to the part thereof. Specifically, reflectance of light is different according to the nail part, the skin part such as the ball of the finger, and the part of the finger on the lateral side. In addition, at the same nail part, for example, the reflectance of light is different according to whether or not a nail is manicured or according to a color or a kind of manicure.

In the identification unit that optically identifies the kind of the operator positioned on the display face of the display unit, the “kind of operator” is the part of the operating finger, that is, the part of the nail (the nail part), the part of the skin (the skin part), and the part of the lateral side (lateral side part), for example, in a case of a finger. In addition, when it is specialized in the nail part, the “kind of operator” is the manicured nail, the non-manicured nail, the color or kind of the manicure, and the like.

Herein, the case where the operator is the finger is exemplified, but a dedicated operator having a plurality of parts with different reflectance, for example, a dedicated pen with reflectance different for each core in a 3-core ballpoint pen may be used.

From the above viewpoint, preferably, the identification unit identifies the kind of the operator on the basis of reflectance light from the operator positioned on the display face of the display unit. Herein, the “positioned on display face of display unit” means a state where the operator comes in contact with the display face of the display unit or approaches the display face within a predetermined distance.

The identification unit may identify the kind of the operator on the basis of irradiation light quantity of a light emitting element provided in the display unit and incident light quantity of the light receiving element that receives the light emitted from the light emitting element and reflected by the operator and is provided in the display unit. Specifically, the reflectance of the operator is calculated on the basis of the irradiation light quantity of the light emitting element and the incident light quantity of the light receiving element, and it is possible to identify the kind of the operator on the basis of the calculated reflectance of the operator.

A light emitting element of a pixel of the display unit may be employed as the light emitting element provided in the display unit. In this case, the light emitted by the light emitting element is visible light. When the display unit corresponds to the color display, the light is each color of light of, for example, R, G, and B. The light emitting element provided in the display unit is not limited to the light emitting element of the pixel of the display unit, and may be a light emitting element that emits light other than visible light such as infrared light.

When the light emitting element provided in the display unit is the light emitting element of the pixel, the light emitting element is preferably a self-emitting element. When the light emitting element is the self-emitting element, the display unit may be a flat panel type (flat type) of display unit, and particularly, it is possible to install it on a mobile information terminal. In addition, even when the dedicated light emitting element is not provided for the pixel, it is possible to obtain light for detecting an operation position of the operator for each pixel. The self-emitting element may be, for example, an organic EL (electroluminescence) element, an LED (a light emitting diode), a plasma element, and the like.

The organic EL panel (the display device) formed using the organic EL element as the self-emitting element has the following characteristics. That is, the organic EL element can be driven by an application voltage of 10 V or lower, which is low power consumption. In addition, the organic EL element is the self-emitting element, visibility of an image is high, response speed is very high, being of several μsec, and thus an afterimage does not occur when a moving picture is displayed.

The organic EL element is kept in a reverse bias state, and thus it is possible to use the organic EL element as the light receiving element. Accordingly, when the organic EL element is used as the self-emitting element, it is preferable to use the organic EL element even though it is the light receiving element. In such a manner, it is possible to form the light emitting element and the light receiving element on the same wiring layer or transistor layer in the same process, and thus there is an advantage of reducing a manufacturing cost. However, the organic EL element used as the light receiving element is an example of an element using a photoelectric convertible organic film, and is not limited to the organic EL element.

The light receiving element is provided corresponding to the light emitting element, and preferably, is provided between the same color of pixels. In such a manner, it is possible to receive light for each pixel in order to detect the operation position of the operator, which is emitted from the light emitting element for each pixel, and thus it is possible to detect the operation position of the operator for each pixel. In addition, a light shielding wall may be provided around the light propagation path to the light receiving element. Accordingly, it is possible to shield the direct light from the light emitting element so as not to be input to the light receiving element, and thus the direct light is not disturbance in measuring the reflectance of the operator.

The light emitting element and the light receiving element of the pixels may be formed on the same semiconductor substrate. In addition, the light receiving element may be a photodiode, specifically, a photodiode having a back face irradiation type sensor structure of receiving light from the opposite side to the side on which the wiring layer is disposed, on the semiconductor substrate on which the light receiving element is formed, and a photodiode having a front face irradiation type sensor structure of receiving light from the front face side. In the light receiving element, it is possible to perform color separation even when a color filter is not used, by changing the formation position in the depth direction of the formed semiconductor substrate. The light receiving element may be formed at the same depth position to perform the color separation based on the color filter.

According to the configuration of optically identifying the kind of the operator, it is possible to perform the operation with the same feeling as that of the touch panel even when the touch panel is not provided on the display unit. Particularly, for example, when the operator is the finger, it is possible to perform the operation using various nails and skin. In addition, when painting software is used, conversion of colors can be performed as an intuitive operation, and thus it is possible to perform drawing with a feeling of drawing a picture or writing text on a recording medium such as a notebook, or the like. Accordingly, it is possible to significantly improve operability and usability in various electronic apparatuses such as a music player, a mobile phone, a personal computer, a tablet PC, and a games console.

In addition, the display unit of the electronic apparatus has a display panel structure having the light receiving element, and the usage of acquiring a situation of external light is conceivable as well as the usage as the touch panel. That is, it is possible to determine whether or not the periphery is a bright environment or a dark environment. Accordingly, it is possible to change the brightness of the display unit according to the brightness of the periphery. For example, it is possible to perform a control of increasing the brightness of the display unit when the peripheral light quantity is relatively bright and decreasing the brightness of the display unit when the peripheral light quantity is relatively dark. Particularly, when the light receiving element is provided corresponding to the pixel, it is possible to determine the brightness of the entire display screen of the display unit, and thus it is possible to adjust the brightness by precise illumination intensity corresponding to the screen.

In addition to the configuration of optically identifying the kind of the operator, the touch panel is disposed on the display face of the display unit, and it is possible to detect the operation based on the operator by the touch panel. In addition, a sound collector that detects a sound when the touch panel is operated by the operator is provided, and a method of identifying the kind of the operator on the basis of a frequency component of the sound and a method of optically identifying may be commonly used. Alternatively, a method of identifying the kind of the operator on the basis of the change of small current flowing on the display face of the display unit and a method of optically identifying may be commonly used.

2. Electronic Apparatus according to Embodiment

Hereinafter, a specific example of the electronic apparatus according to the embodiment of the present disclosure, that is, the electronic apparatus which is provided with a display unit and is capable of performing various operations on the display face of the display unit will be described.

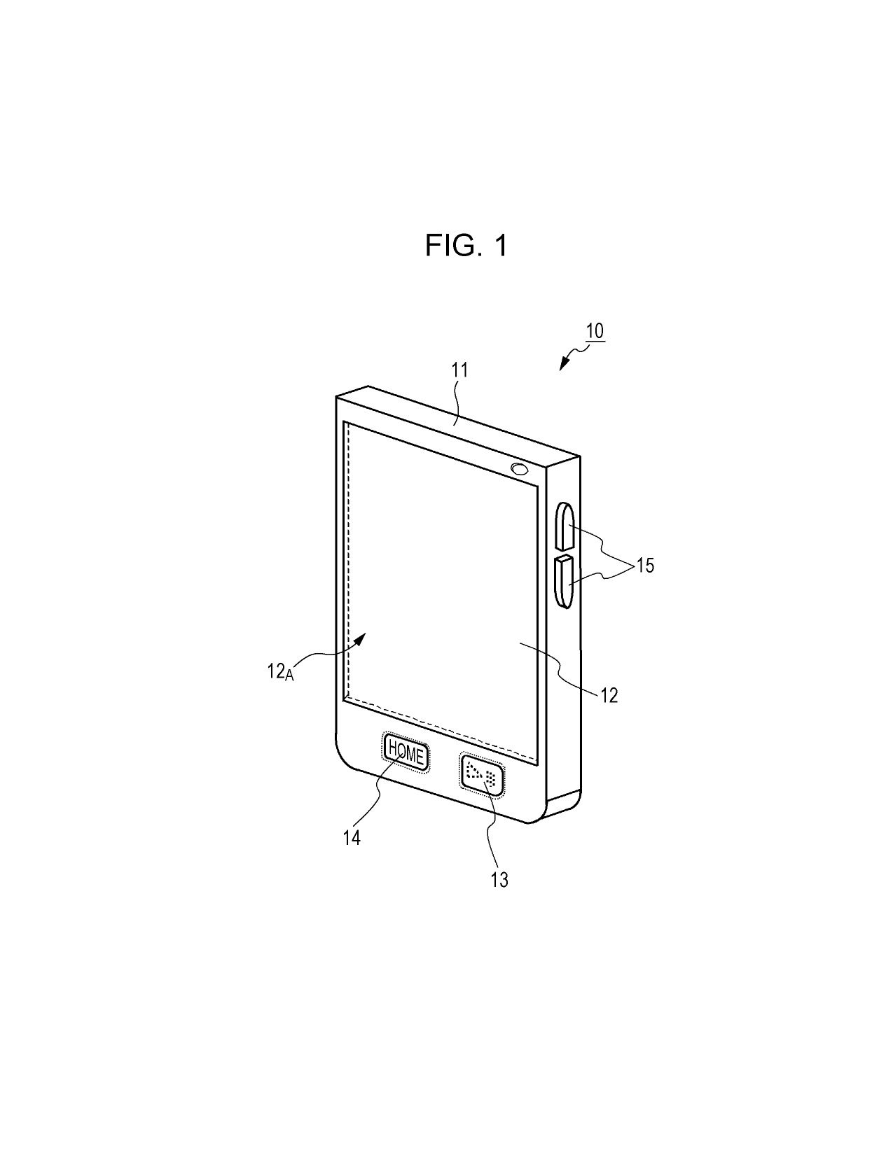

FIG. 1 is a perspective view illustrating a schematic appearance of the electronic apparatus according to the embodiment of the present disclosure, for example, a portable music player. As shown in FIG. 1, the music player 10 according to the embodiment of the present disclosure has a flat main body unit 11 in which both of a front face and a back face are formed in a substantially rectangular shape. On the front face side of the main body unit 11, a display unit 12 having, for example, a rectangular information display face 12_{A} is provided.

On the information display face 12_{A} of the display unit 12, it is possible to display a display screen with various configurations such as a display screen having one or more indicators and a display screen listing and displaying predetermined information. In addition, various display screens may be independently displayed on the information display face 12_{A} of the display unit 12, and other information such as another display screen or one or more indicators may be overlapped and displayed on a specific display screen.

In the music player 10 according to the embodiment, it is possible to perform various operations in a touch panel manner directly from the display unit 12, that is, on the information display face 12_{A}. More specifically, in the music player 10 according to the embodiment, for example, even when the touch panel is not provided on the information display face 12_{A}, it is possible to perform the operation with the same feeling as that of the touch panel.

Particularly, the music player 10 according to the embodiment optically identifies the kind of the operator positioned on the information display face 12_{A} according to the operation, and controls the content of the operation for the display unit 12 according to the kind of the identified operator. Details thereof will be described later.

A play/stop button 13 for instructing start and stop of play, and a home button 14 for instructing a home menu screen are disposed on the lower side on the front face of the main body unit 11. In addition, on one lateral side of the main body unit 11, volume adjusting buttons 15 for adjusting a volume are provided.

In the electronic apparatus having the display unit such as the portable music player described above, specific examples of optically identifying the kind of the operator positioned on the display face of the display unit, and controlling the content of the operation for the display unit according to the identified kind of the operator will be described hereinafter.

### 2-1. Example 1

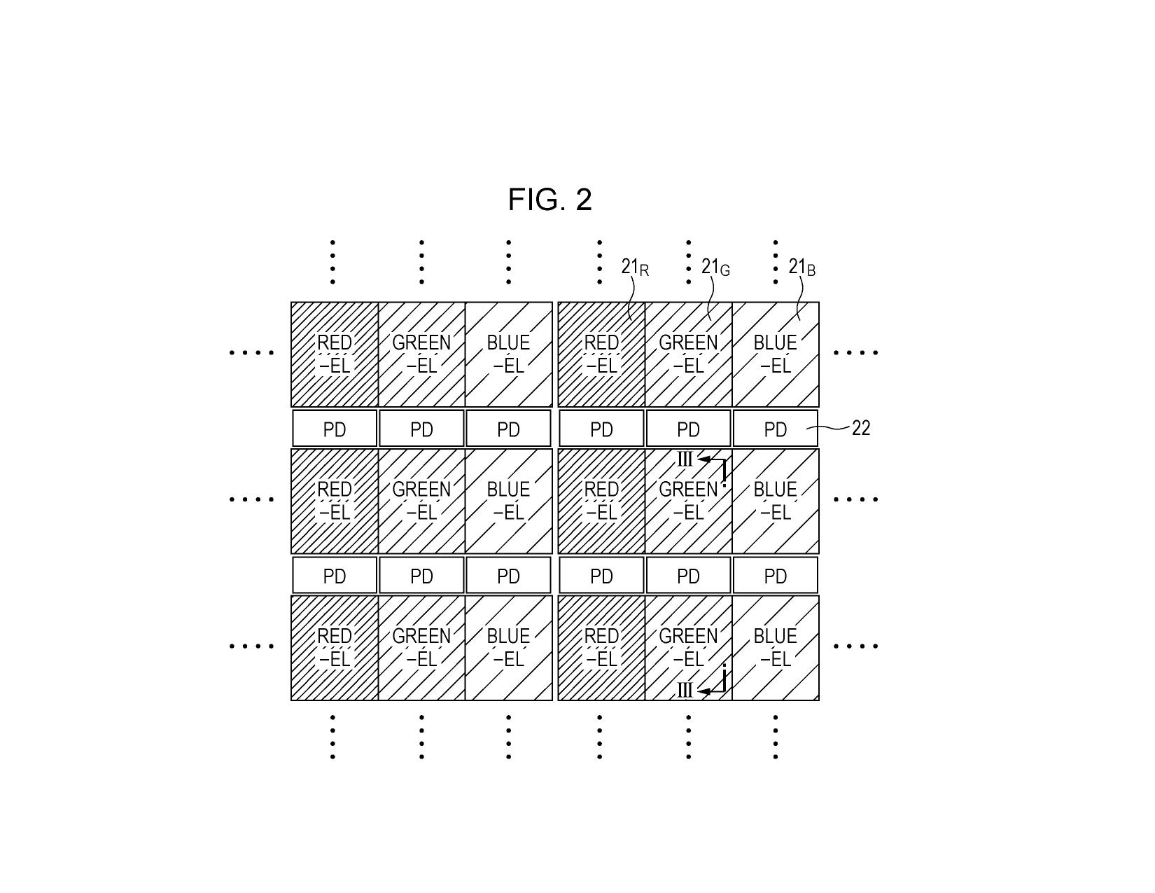

FIG. 2 is a plan view illustrating an example of layout of the light emitting element and the light receiving element in the display unit according to Example 1. In the display unit 12 according to Example 1, for example, an organic EL element is used as the light emitting element, for example, a photodiode is used as the light receiving element, and a display panel is configured in which the sub-pixels (hereinafter, also merely referred to as “pixel”) of RGB are arranged in a stripe shape for each color.

In the pixel arrangement formed by arranging the organic EL elements 21_{R}, 21_{G}, and 21_{B} of RGB in a stripe shape, the photodiode 22 performing photoelectric conversion of the incident light to detect light quantity is provided corresponding to each of the organic EL elements 21_{R}, 21_{G}, and 21_{B}. More specifically, the photodiode 22 is provided between the same color of pixels (the organic EL elements).

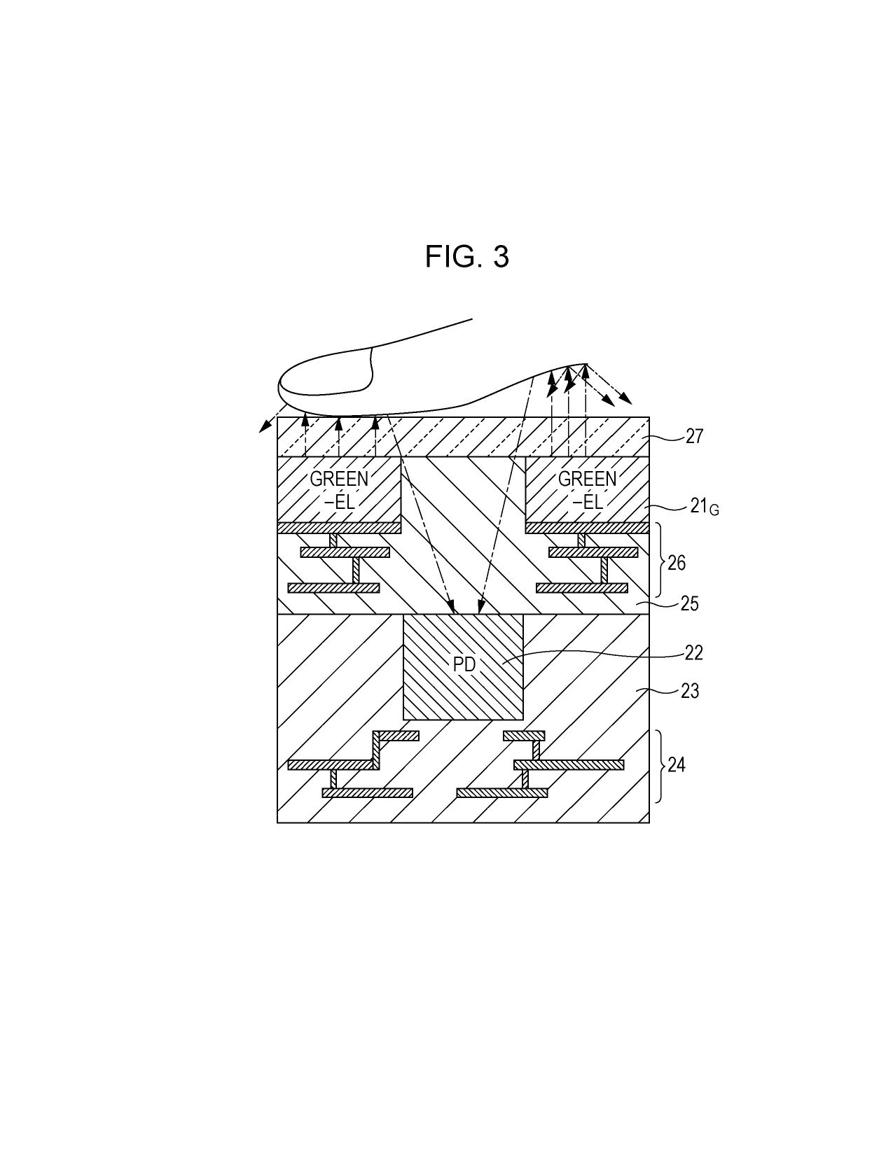

FIG. 3 shows a cross-sectional structure taken along the line III-III of FIG. 2. In FIG. 3, the photodiode 22 and the wiring layer 24 are formed in the semiconductor substrate 23. When the side on which the wiring layer 24 is formed in the semiconductor substrate 23 is the front face, the photodiode 22 has a so-called back face irradiation type sensor structure of being disposed on the opposite side to the side on which the wiring layer 24 is disposed, that is, the back face side and receiving the light from the back face side of the semiconductor substrate 23.

An element formation layer 25 is provided on the semiconductor substrate 23. The organic EL elements 21_{R}, 21_{G}, and 21_{B} of R, G, and B are formed on the opposite side to the semiconductor substrate 23 of the element formation layer 25, and a wiring layer 26 including electrodes of the organic EL elements 21_{R}, 21_{G}, and 21_{B} is formed on the semiconductor substrate 23 side. A transparent protective film 27 is provided on the light output side of the element formation layer 25.

In the display unit 12 according to Example 1 with the configuration, the light emitted from the organic EL elements 21_{R}, 21_{G}, and 21_{B} is used as display light displaying an image or the like on the information display face 12_{A} of the display unit 12 shown in FIG. 1, and is used as detection light detecting the operator positioned on the information display face 12_{A}.

That is, the operator positioned on the information display face 12_{A} is also irradiated with the light emitted from the organic EL elements 21_{R}, 21_{G}, and 21_{B}. The light reflected from the operator is input to the photodiode 22. Herein, the irradiation light quantity of the light based on the organic EL elements 21_{R}, 21_{G}, and 21_{B} and the incident light quantity input to the photodiode 22 are in the same device. Accordingly, it is possible to calculate the reflectance (that is, the incident light quantity to the photodiode 22/the irradiation light quantity of the organic EL elements 21_{R}, 21_{G}, and 21_{B}) of the operator from such light quantity.

Herein, a case where the operator is a finger is exemplified. By operating the information display face 12_{A} of the display unit 12 by the finger, particularly, as shown in FIG. 3, the upper side of the photodiode 22 is covered by the finger, and thus the photodiode 22 is not easily affected by external light. In addition, the reflectance of the finger is different according to the part thereof. Specifically, the reflectance of light is different according to the part of the nail (the nail part), the part of the skin (the skin part) such as the ball of the finger, and the part of the finger on the lateral side (the lateral side part). Accordingly, the reflectance is different according to the parts of the finger, and thus it is possible to control the content of the operation for the display unit 12.

### Configuration of Control System

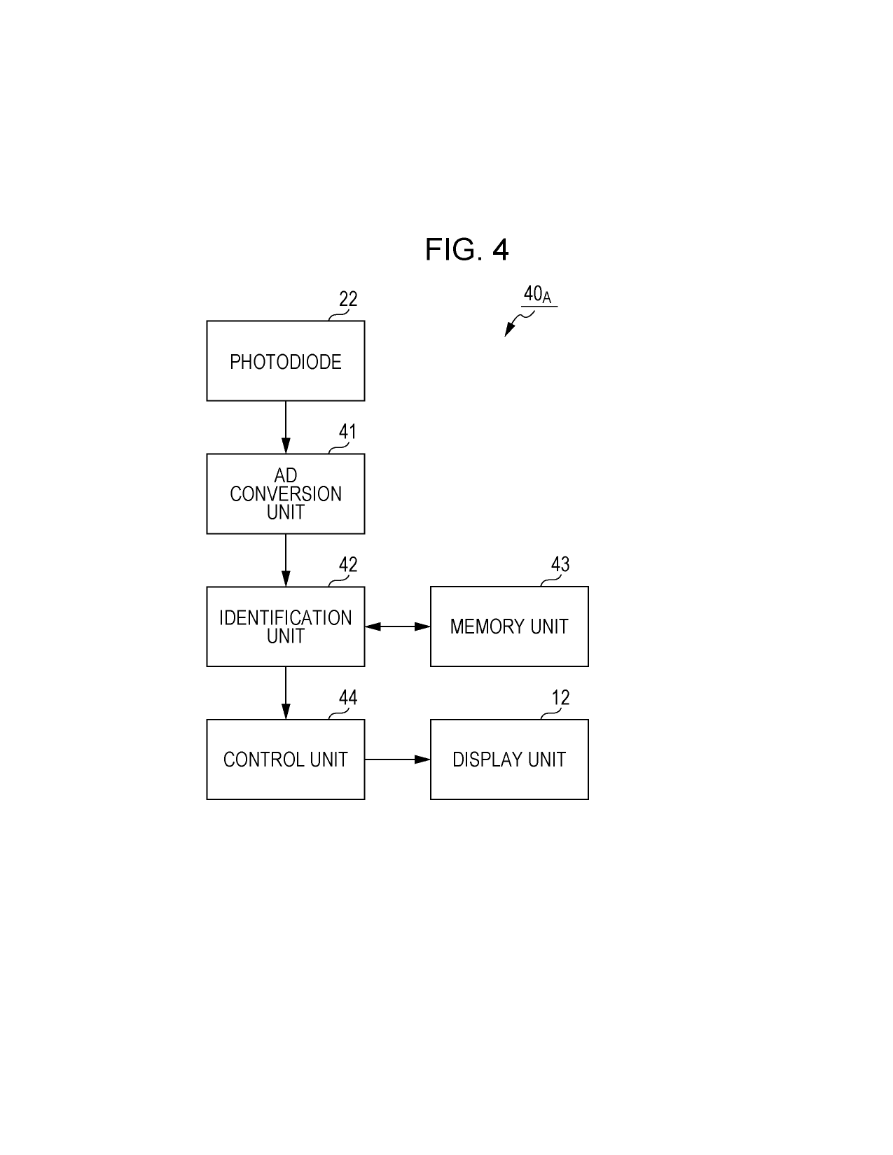

FIG. 4 is a block diagram illustrating an example of a configuration of a control system according to Example 1 in which the operation content is controlled on the basis of the reflectance of the operator.

The control system 40_{A} according to the example includes an AD conversion unit 41, an identification unit 42, a memory unit 43, and a control unit 44, and the operation content of the display unit 12 is controlled under the control of the control unit 44 on the basis of an output signal of the photodiode 22.

The AD conversion unit 41 converts an analog signal transmitted from the photodiode 22 into a digital signal, and transmits the digital signal to the identification unit 42. The identification unit 42 identifies a touch position of the finger on the information display face 12_{A} of the display unit 12 or an object (a nail, skin, or the like) on the basis of the digital value transmitted from the AD conversion unit 41.

Herein, to determine whether the finger is touched on the information display face 12_{A} of the display unit 12 on the basis of the output of the photodiode 22, it is necessary to consider the influence of the external light. For example, when the electronic apparatus is used during the daytime in the field, or the like, the external light is also input to the photodiode 22. The touch or non-touch is determined according to whether or not the external light is input. That is, the external light is blocked at the part touched with the finger, and the reflection from the organic EL elements 21_{R}, 21_{G}, and 21_{B} is a main component.

As shown in FIG. 2 and FIG. 3, for example, the green light is mainly input to the photodiode 22 interposed between the green organic EL elements 21_{G}. For red and blue, the same is applied. That is, the photodiode 22 interposed between two adjacent pixels of the organic EL elements 21_{R}, 21_{G}, and 21_{B} performs outputting corresponding to an RGB light emitting ratio of the display unit 12 when a finger touches.

As shown in FIG. 2 and FIG. 3, the photodiode 22 is disposed between the same color of organic EL elements 21_{R}, 21_{G}, and 21_{B}, and it is possible to see wavelength dependency of the reflected light even when the photodiode 22 is not provided with the color filter.

A specific output ratio of the photodiode 22 is as follows.

Output Ratio =RGB Light Emitting Ratio of Organic EL Element×RGB Sensitivity Ratio of Photodiode×Color Reflectance Wavelength Dependency

Hereinafter, the light emission brightness of the organic EL elements 21_{R}, 21_{G}, and 21_{B} is a brightness value of light intentionally emitted by the device, and thus is known. The spectrum characteristics of the photodiode 22 are also designable, and thus are known. Each color wavelength dependency of the reflection portion of the operator is changed according to objects, and thus has to be stored in advance as a parameter having a range. The parameter is stored in advance in the memory unit 43.

In addition, to more accurately perform the identification of the reflector, the user of the electronic apparatus may cause the electronic apparatus to individually read the reflectance of nail or skin of the user's finger to be registered in advance. The information of the reflectance in that case is stored in advance in the memory unit 43.

In such a manner, it is possible to cope with a case of an individual difference of the reflection and a manicured nail. For example, the nails of all fingers are manicured with different reflectance, and it is possible to change the operation content with the individual fingers. In addition, for the usage of security, only a user of reflectance registered in advance can use the electronic apparatus using the individual difference of reflectance.

The identification unit 42 performs an identification process of a touch position and a touch object of the operator with reference to the storage information of the memory unit 43, and transmits the identification result to the control unit 44. The control unit 44 is configured by a microprocessor or the like, controls the operation content for the display unit 12 on the basis of the identification result transmitted from the identification unit 42, and displays information corresponding to the operation content on the information display face 12_{A} of the display unit 12.

### Operating Method

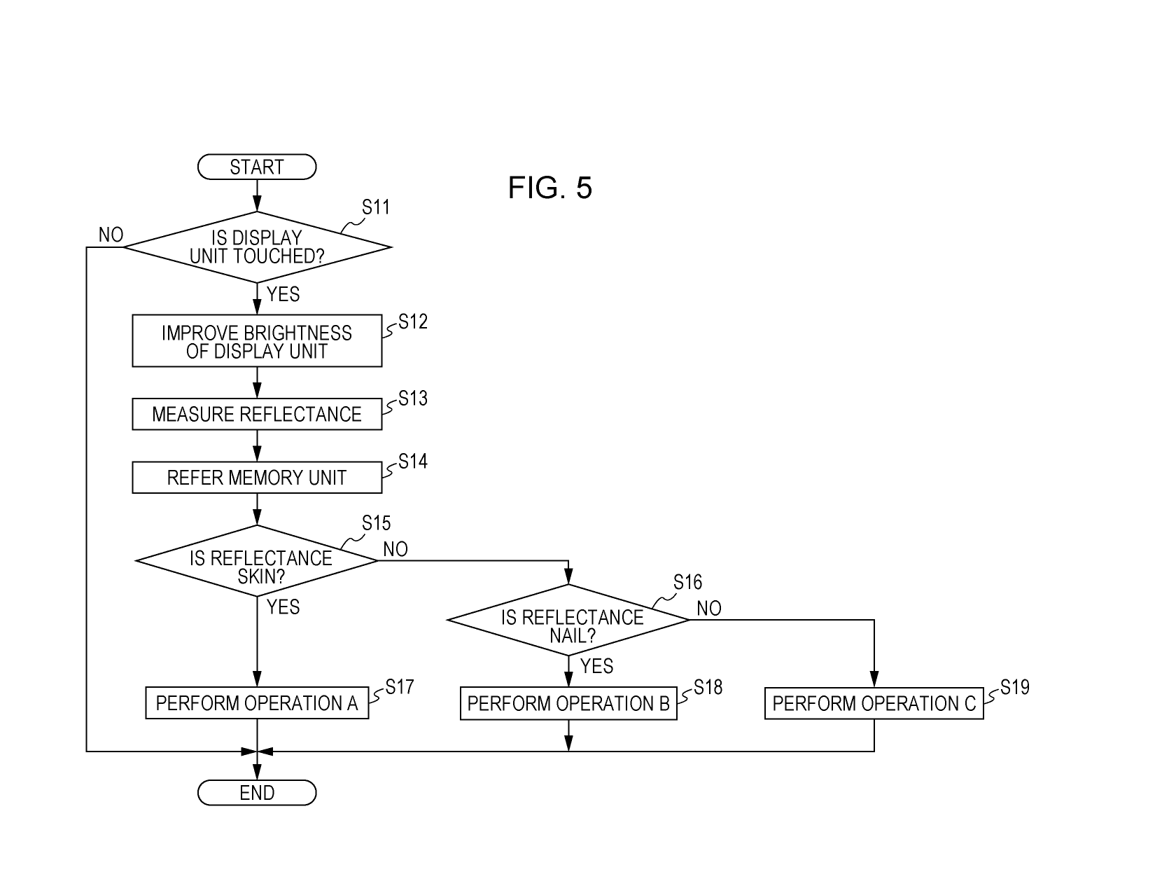

Subsequently, a process sequence (that is, a process sequence of the operating method according to an embodiment of the present disclosure) performed under the control of the control system 40_{A} according to Example 1 with the configuration described above will be described with reference to a flowchart of FIG. 5.

First, it is determined whether or not the information display face 12_{A} of the display unit 12 is touched with the operator, that is, a finger in the present example, according to, for example, as described above, whether or not the external light is input to the photodiode 22 (Step S11). When it is determined that the information display face 12_{A} is touched, a process of increasing the light emission brightness of the part touched with the operator to raise precision of reflection measurement is performed (Step S12). However, the process of increasing the light emission brightness is arbitrary. That is, the process may or may not be performed. Even when the light emission brightness is increased, the part is covered by the finger, it is not applied to the information viewed by eyes of the user.

Next, the reflectance of the finger is measured on the basis of the output of the photodiode 22 (Step S13), and then the memory unit 43 is referred on the basis of the measurement result (Step S14). In addition, it is determined whether the reflectance of the finger part touched on the information display face 12_{A} of the display unit 12 is the reflectance of the skin, the reflectance of the nail, or the other reflectance (Step S15 and Step S16).

In Step S15, when it is determined that the part of the finger touched on the information display face 12_{A} is the skin part, that is, when the measured reflectance is similar to the reflectance of the skin stored in the memory unit 43, an operation A is performed (Step S17). In Step S16, when it is determined that the finger part touched on the information display face 12_{A} is the nail part, that is, when the measured reflectance is similar to the reflectance of the nail stored in the memory unit 43, an operation B is performed (Step S18).

In Step S15 and Step S16, when it is determined that the finger part touched on the information display face 12_{A} is not the skin part and the nail part, and an operation C is performed (Step S19). Herein, it is determined that the finger part is not the skin part and the nail part, the operation C is performed, but the process may be ended without performing anything. The operation content of the operations A to C is the operation contents stored in advance. A specific example of the operation content will be described later.

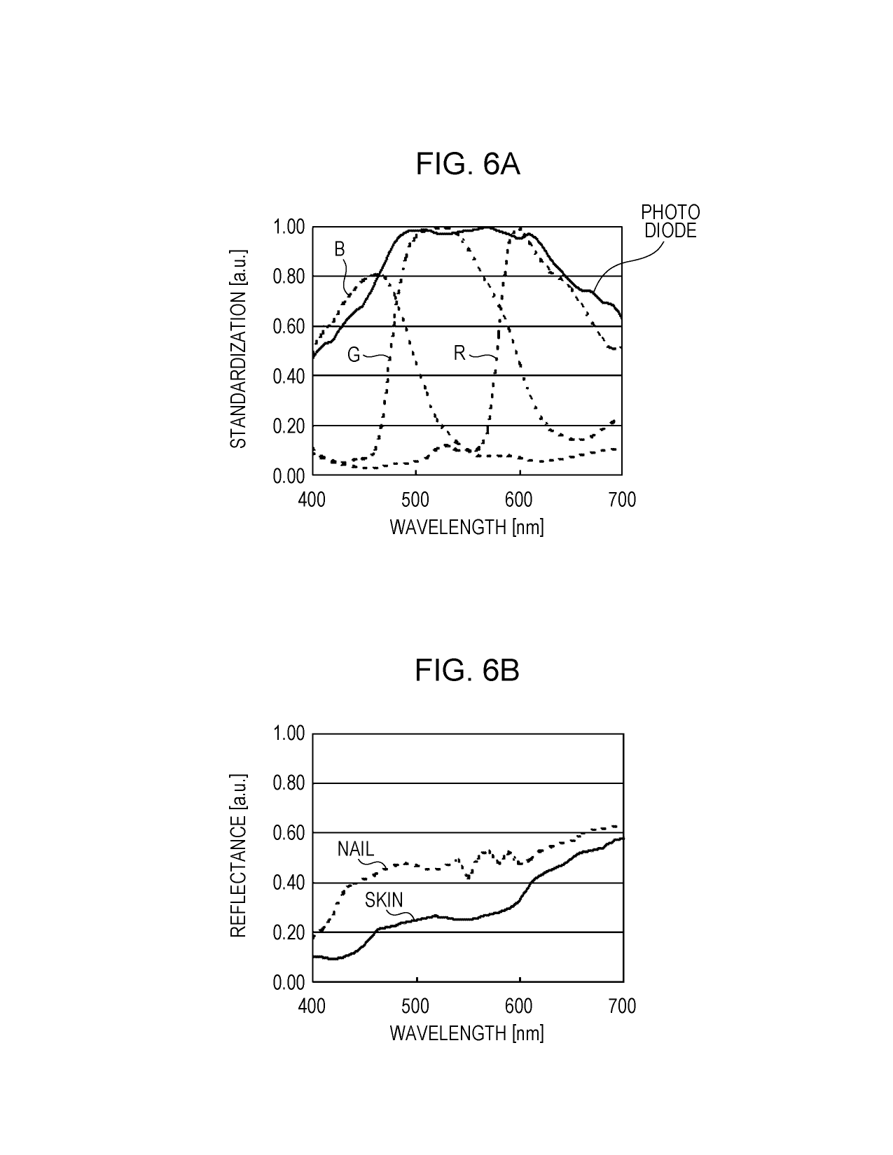

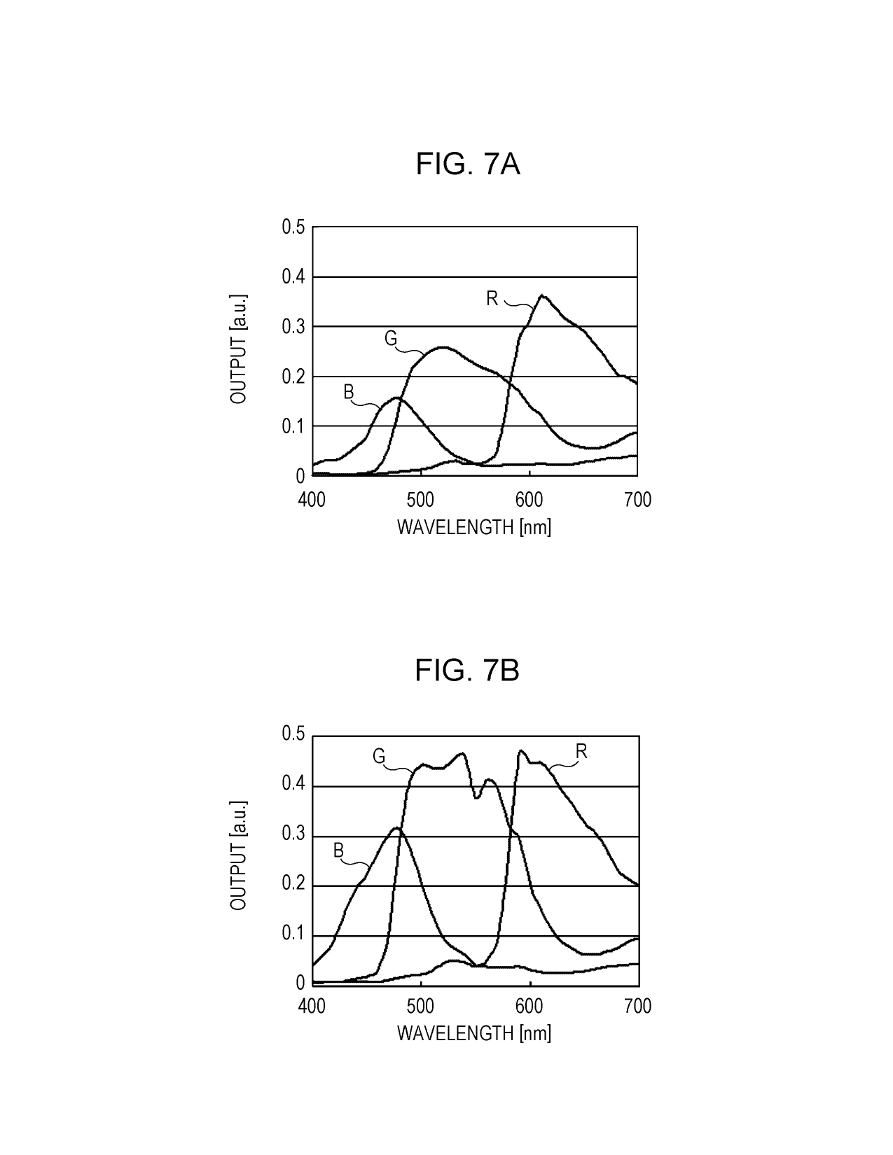

Herein, an example of the output spectrum of the organic EL elements 21_{R}, 21_{G}, and 21_{B} and sensitivity characteristics of the photodiode 22, and an example of reflectance of the nail and the skin, and an output example when the skin and the nail are irradiated with light will be described with reference to FIG. 6A to FIG. 7B.

In FIG. 6A and FIG. 6B, FIG. 6A shows an example of output spectrum of the organic EL elements 21_{R}, 21_{G}, and 21_{B} and sensitivity characteristics of the photodiode 22, and FIG. 6B shows an example of reflectance of the nail and the skin. In addition, in FIG. 7A and FIG. 7B, FIG. 7A shows an output example for each color when the skin is irradiated with light, and FIG. 7B shows an output example for each color when the nail is irradiated with light.

First, in FIG. 6A, it is assumed that spectrum characteristics of the light emission parts of the organic EL elements 21_{R}, 21_{G}, and 21_{B} are represented by dot lines. In FIG. 6A, the sensitivity characteristics of the photodiode 22 are represented by a solid line. In addition, in FIG. 6B, the reflectance of the skin of the user using the electronic apparatus 10 according to the embodiment is represented by a solid line, and the reflectance of the nail is represented by a dot line.

With respect to the part touched by the finger, when light is emitted equivalent to the output represented by the dot line shown in FIG. 6A, the output in the photodiode interposed between the blue light emission pixels is obtained by multiplying the value obtained by multiplying the blue light emission (the dot line shown in FIG. 6A) by the reflectance of the target substance (FIG. 6B), by the spectrum characteristics (the solid line shown in FIG. 6A) of the photodiode 22. The same is applied to the photodiode interposed between the pixels of the green light emission and the red light emission.

As a result, the output when the skin is irradiated with light is an integration value of the output shown in FIG. 7A, and the output when the nail is irradiated with light is an integration value of the output shown in FIG. 7B. Ratios of the integration values are as follows.

Skin R:G:B=3.7:3.6:1.6

Nail R:G:B=4.9:6.0:3.1

In a case of this result, it is determined that the ratio of occupancy of the green in the nail is higher than that of the skin. In a case of such a condition, it is identified that the nail is touched (this ratio is merely a referential example). In addition, an absolute value of the reflection light may be detected as well as the ratio.

Since there is an individual difference in the characteristics of the skin and the nail, a method of registering a width to some extent and registering the output characteristics by the user before using in the electronic apparatus in advance is conceivable.

### Specific Example of Operation Content

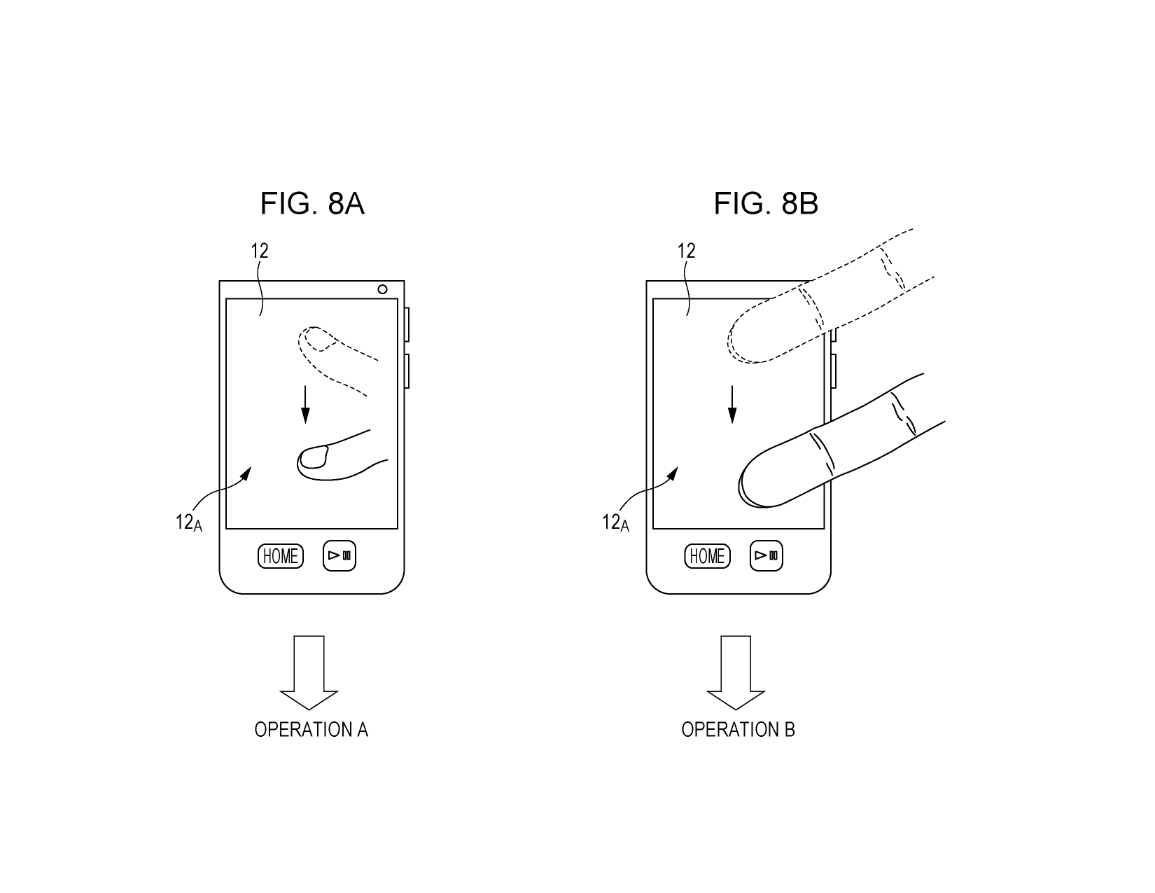

Next, a specific example of the operation content for the display unit 12 such as the assumed operations A and B or the like described above will be described with reference to FIG. 8A to FIG. 10B.

Herein, as an example, when the operator is a finger, as shown in FIG. 6B, a case of changing the operation content according to the difference in reflectance between the skin with the relatively low reflectance and the nail with the relatively high reflectance will be described by way of example.

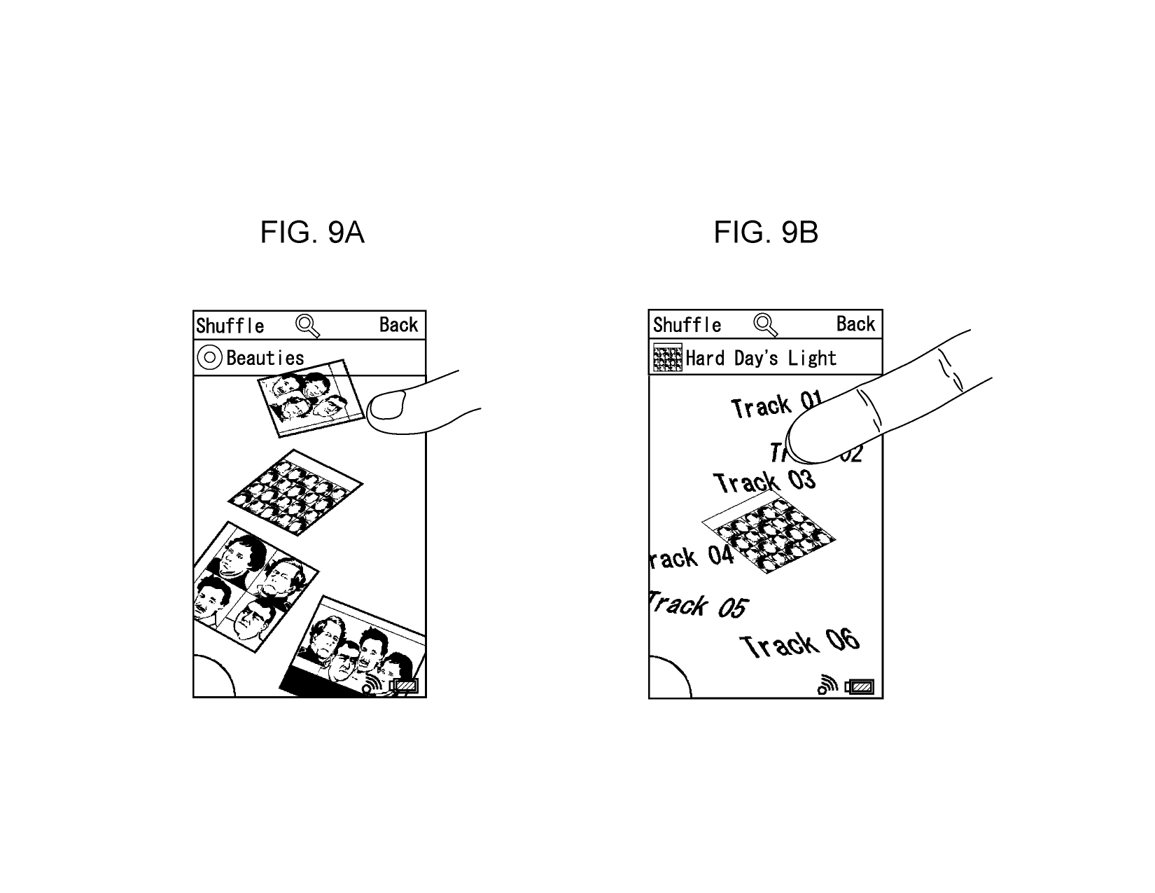

As shown in FIG. 8A and FIG. 8B, when the user touches the information display face 12_{A} of the display unit 12 with the skin part (FIG. 8A), the “Operation A” is performed, and when the user touches the information display face 12_{A} with the nail part (FIG. 8B), the “Operation B” is performed. Specific examples of the operation A and the operation B are shown in FIG. 9A and FIG. 9B.

FIG. 9A and FIG. 9B show a use example in the music player. At the time of music selection, when the operation is performed with the skin (FIG. 9A), a screen of selecting an artist (a singer) is displayed, and when the operation is performed with the nail (FIG. 9B), a screen of selecting a song title is displayed. In the related art, an operation of searching a singer name or a song title has to change modes by the other operation. However, by applying the operating method according to the embodiment, for example, the conversion of modes can be realized by substances with different reflectance such as the skin or the nail of the finger, and thus it is possible to perform the more intuitive operation.

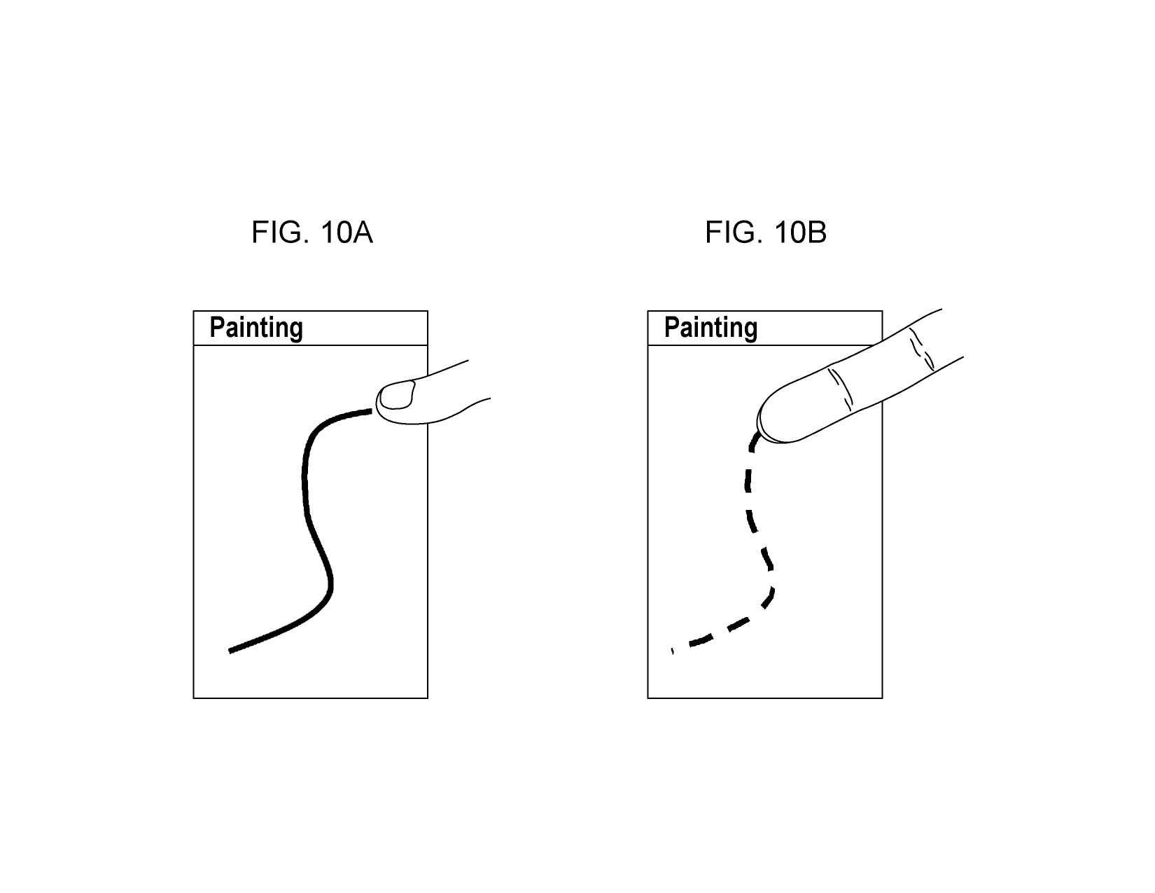

FIG. 10A and FIG. 10B show an example of using painting software. Herein, the “painting software” is graphic software for 2-dimensional computer graphics drawing on the computer. When the operation is performed with the skin (FIG. 10A), a solid line is drawn along a trace of the skin, and when the operation is performed with the nail (FIG. 10B), a broken line is drawn along a trace of the nail.

In this example, the cases of the solid line drawing (FIG. 10A) and the broken line drawing (FIG. 10B) are exemplified, but this is merely an example. For example, when the operation is performed with the skin, a black line may be drawn along a trace of the skin, and when the operation is performed with the nail, a red line may be drawn along a trace of the nail. As described above, various operation content may be performed.

### Other Example of Layout of Light Emitting Element and Light Receiving Element

Concerning the layout of the organic EL elements 21 (21_{R}, 21_{G}, and 21_{B}) that are the light emitting elements and the photodiodes 22 that are the light receiving elements, in the examples shown in FIG. 2 and FIG. 3, simply, the layout structure of disposing the photodiode 22 between the same color of pixels (the organic EL elements 21) is employed.

In addition to the layout structure described above, the following layout structure may be employed.

### Other Layout Example 1

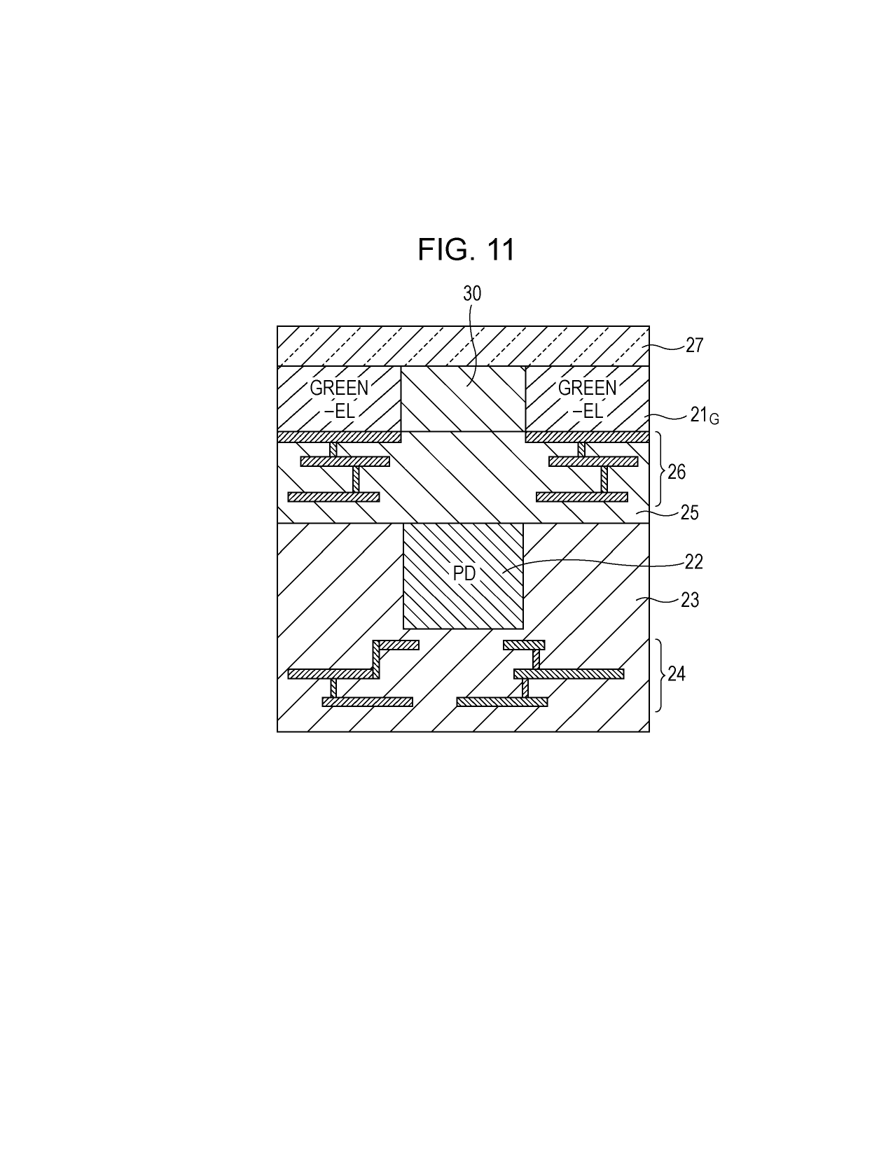

For example, as shown in FIG. 11, a color filter 30 may be provided on the photodiode 22, and a layout structure of more accurately performing color separation may be provided. In the examples shown in FIG. 2 and FIG. 3, it is assumed that the reflection light from the operator input to the photodiode 22 interposed between the green organic EL elements 21_{G} has a green wavelength as a main component. To further exclude an influence of a mixed color component from the other organic EL elements 21_{R} and 21_{B}, the color filter 30 is provided on the photodiode 22 (in the case of the example shown in FIG. 11, a color filter for green) to absorb the light other than the green light, and thus it is possible to more reliably perform the color separation.

### Other Layout Example 2

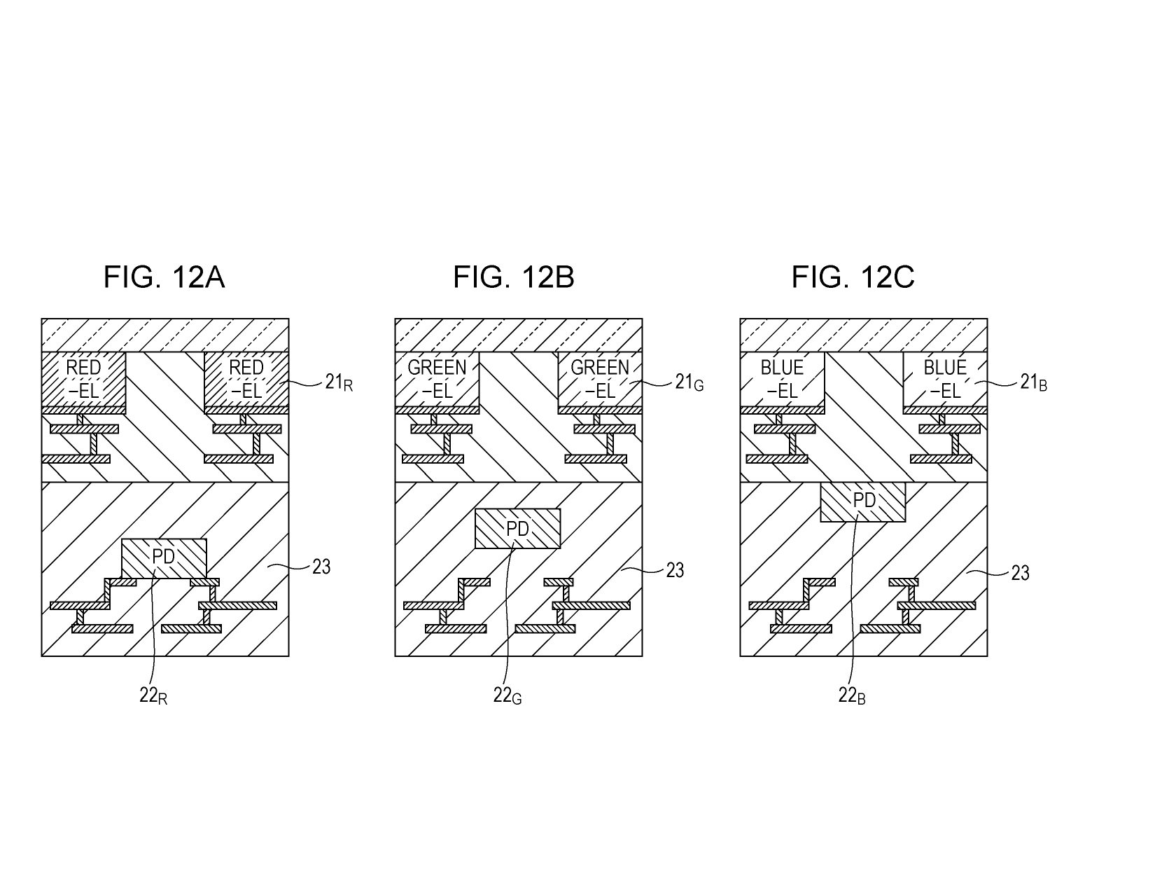

In addition, as shown in FIG. 12A to FIG. 12C, a layout structure of changing the formation positions of the photodiodes 22 in the depth direction of the semiconductor substrate 23 according to colors may be employed. As the light gets closer to a long wavelength (red), the light reaches further inside the semiconductor substrate 23 and is subjected to photoelectric conversion. Accordingly, the red photodiode 22_{R} is formed at the deep position from the substrate surface of the semiconductor substrate 23. In addition, the green photodiode 22_{G} is formed at the position shallower than the red photodiode 22_{R}, and the blue photodiode 22_{B} is formed in the vicinity of the substrate surface of the semiconductor substrate 23.

As an example, it is preferable to form the red photodiode 22_{R} at a depth position of a section of about 1.5 μm to 2.0 μm from the substrate surface. It is preferable to form the green photodiode 22_{G} at a depth position of a section of about 0.7 μm to 1.4 μm from the substrate surface. It is preferable to form the blue photodiode 22_{B} at a depth position of a section of about 0 μm to 0.6 μm from the substrate surface.

As described above, by employing the layout structure of changing the formation positions of the photodiodes 22 (22_{R}, 22_{G}, and 22_{B}) in the depth direction of the semiconductor substrate 23 according to colors, it is possible to simply perform the detection of only a specific color even without providing the color filter 30. As a result, the mixed color based on the other wavelength is blocked, and it is possible to improve precision of detection and determination of substances.

### Other Layout Example 3

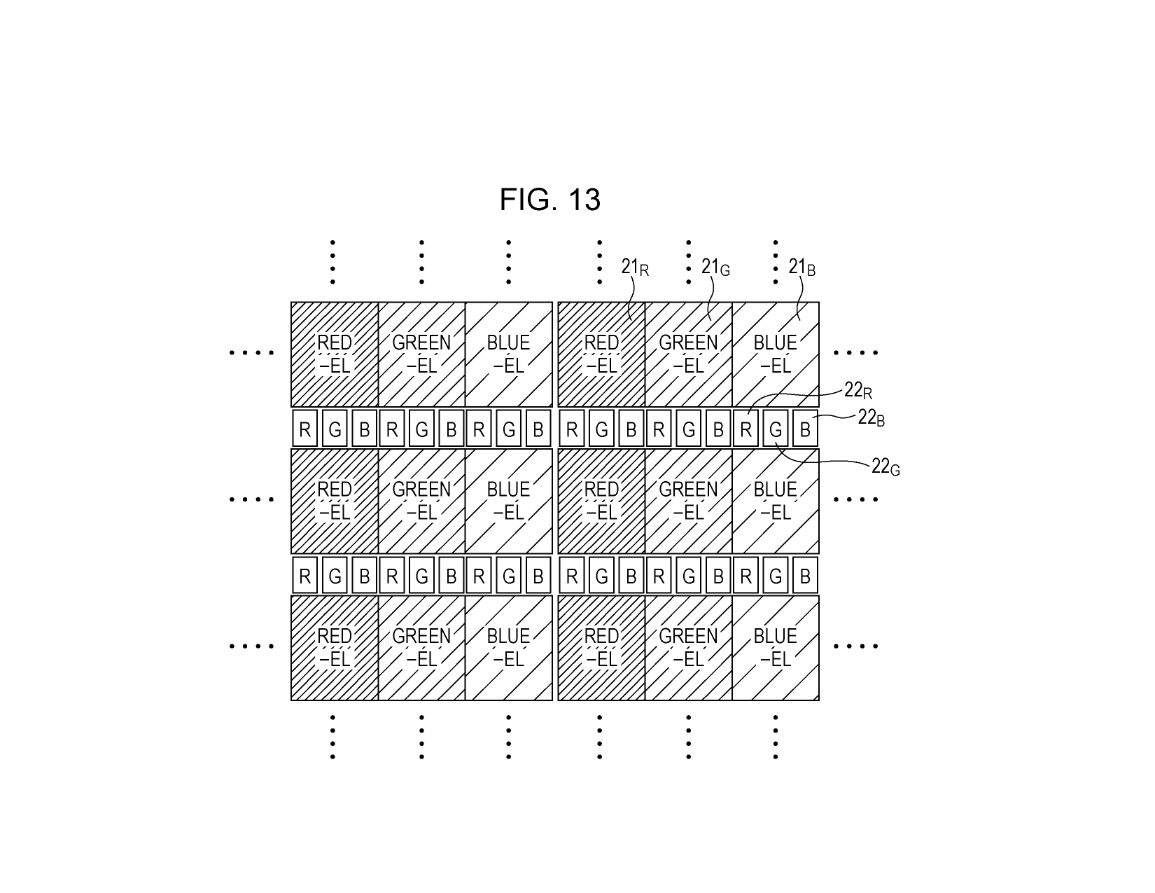

All the layout structures described above are the layout structures in which the photodiode 22 is disposed between the same color of pixels (the organic EL elements 21) according to each color. On the other hand, as shown in FIG. 13, a layout structure in which a unit of the photodiodes 22_{R}, 22_{G}, and 22_{B} of R, G, and B corresponding to each color as the photodiodes 22 is disposed between the same color of pixels (the organic EL element 21) may be employed.

As described above, according to the layout structure of disposing the unit of the photodiodes 22_{R}, 22_{G}, and 22_{B} of R, G, and B between the same color of pixels, it is possible to more precisely analyze the output.

### Other Layout Example 4

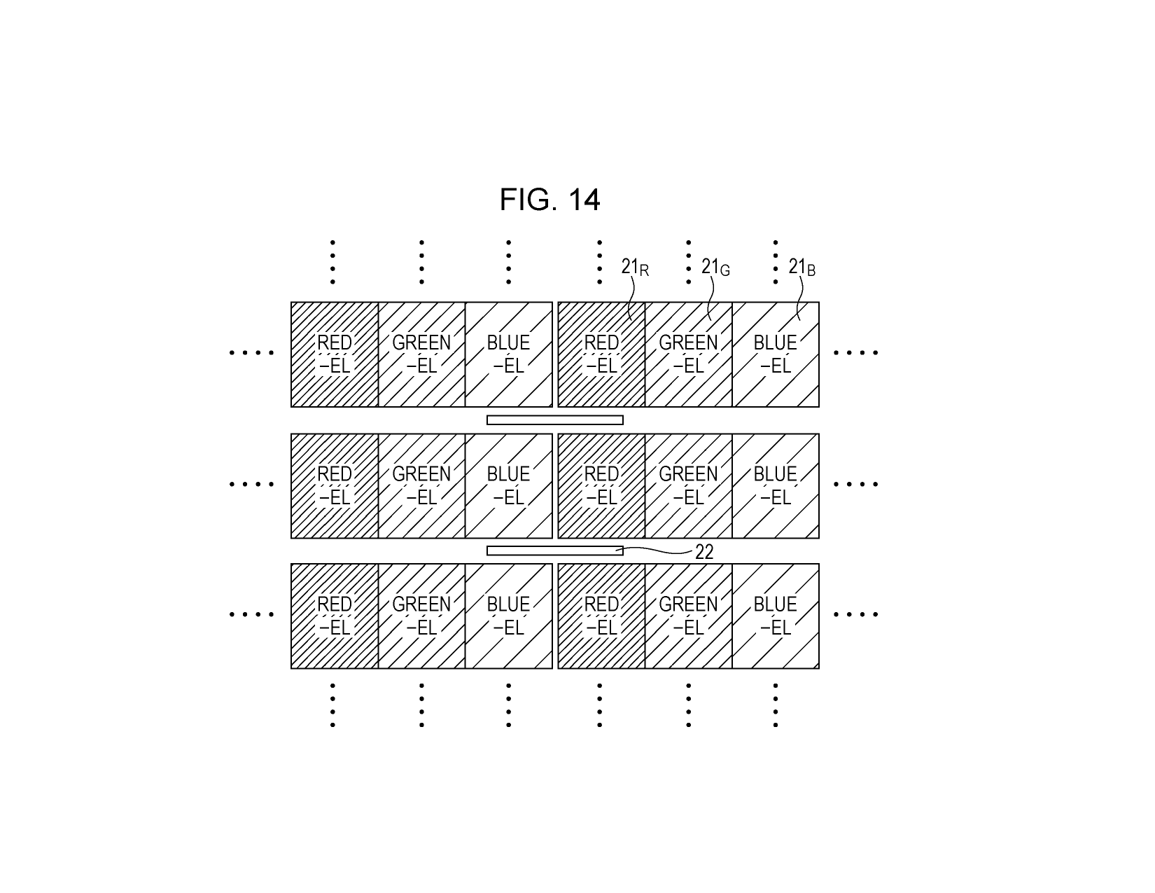

All the layout structures described above are the layout structures depending on wavelengths. On the other hand, when only the absolute amount of reflection is detected without depending on wavelengths, as shown in FIG. 14, a layout structure in which only a part of a pixel array portion formed by disposing the sub-pixels of R, G, and B in matrix is provided with the photodiode 22 may be employed. In addition, the emitted light is not limited to the color light of R, G, and B, and the other light, for example, light other than visible light such as infrared light may be used.

As described above, according to the display unit 12 according to the example, that is, the organic EL panel provided with the photodiode 22, it is possible to perform the operation with the same feeling as that of the touch panel even without providing the touch panel on the information display face 12_{A}. Particularly, it is possible to perform the operation using the nail and the skin, it is possible to perform the color conversion or the like with the intuitive operation when using the painting software or the like, it is possible to perform drawing with the feeling of drawing a picture or writing a text on a recording medium such as a notebook on the display unit 12, and thus it is possible to significantly improve operability.

### 2-2. Example 2

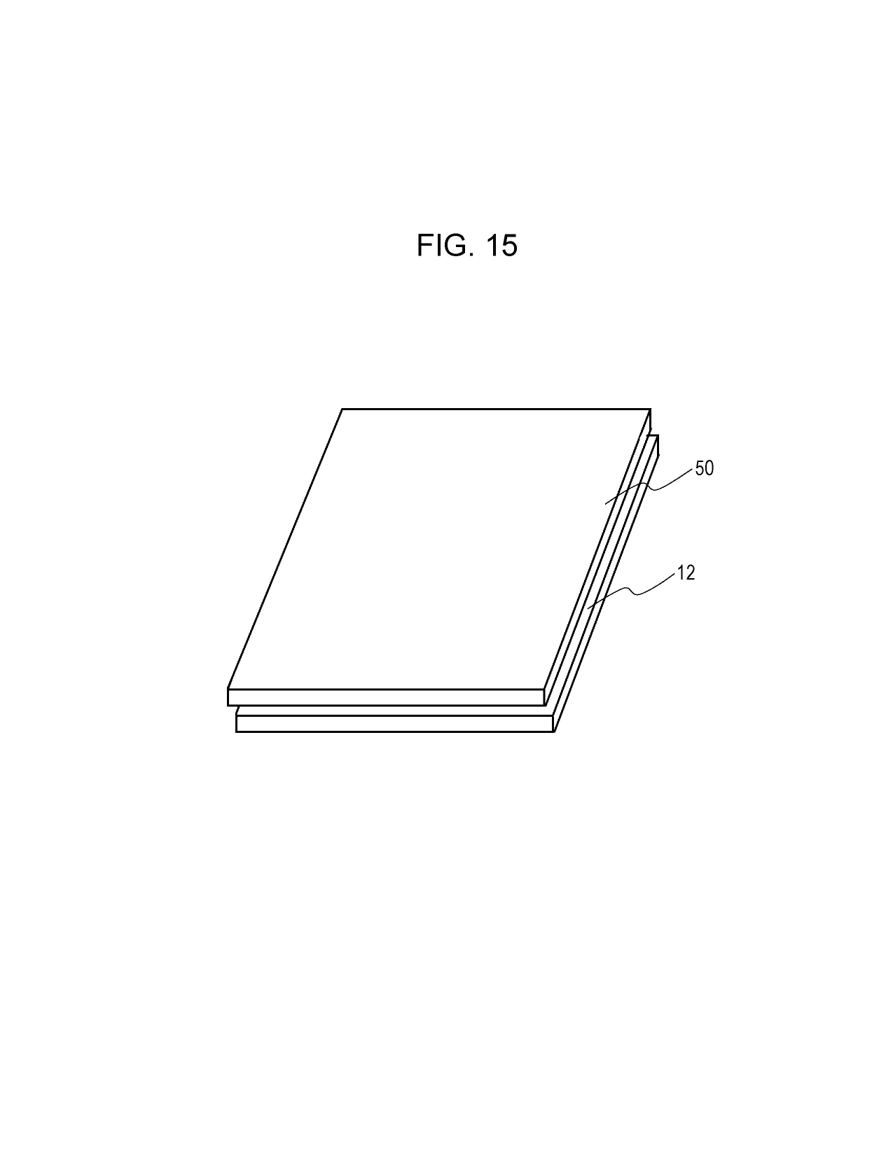

FIG. 15 is a schematic perspective view illustrating an example of a configuration around the display unit according to Example 2.

In Example 1, the configuration of optically performing the detection of the touch position of the operator or the detection of the touched object is employed by the organic EL panel (that is, the display unit 12) provided with the photodiode 22. On the other hand, in Example 2, as shown in FIG. 11, a configuration in which the touch panel 50 is overlapped and disposed on the display unit 12, that is, the organic EL panel provided with the photodiode 22 is employed.

The configuration of the touch panel 50 is not particularly limited. Specifically, as the touch panel 50, a touch panel with the configuration of the related art such as an electrostatic capacitance touch panel, a resistive film touch panel, or an acoustic pulse recognition type panel may be used.

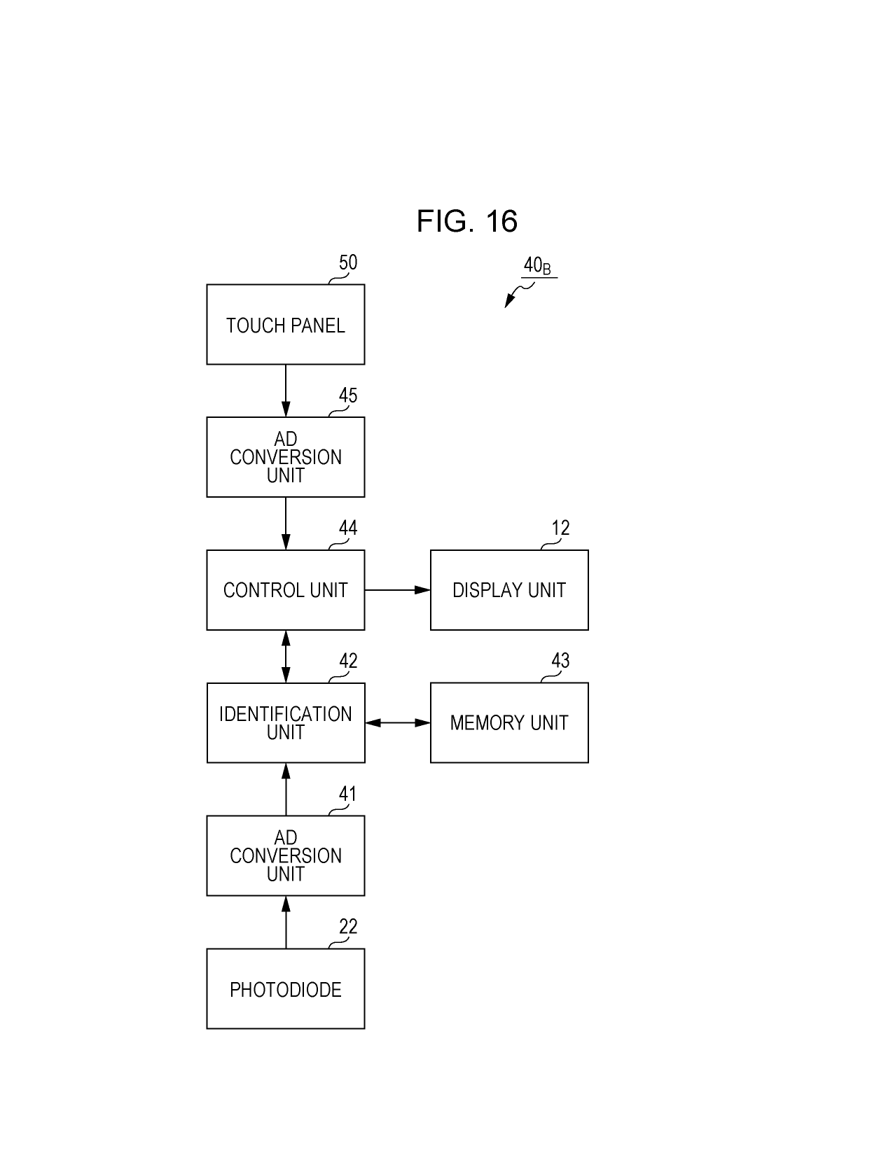

FIG. 16 is a block diagram illustrating an example of a configuration of a control system according to Example 2 commonly using the touch panel 50.

A control system 40_{B} according to Example 2 has a configuration newly including an AD conversion unit 45, in addition to the configuration of the control system 40_{A} according to Example 1, that is, the AD conversion unit 41, the identification unit 42, the memory unit 43, and the control unit 44. When the operator is touched, the touch panel 50 detects the touch and outputs a signal representing the touch position. The AD conversion unit 45 converts an analog signal output from the touch panel 50 into a digital value, and supplies the digital value to the control unit 44.

In the control system 40_{B} according to Example 2 with the configuration described above, when it is confirmed that the operation is performed by the operator on the basis of the signal transmitted from the touch panel 50, the control unit 44 obtains information about what is the touch object of the operator from the identification unit 42. The identification unit 42 identifies whether or not the touch object is the skin part, the nail part, or the other part, when the operator is, for example, a finger on the basis of the object information from the photodiode 22 with reference to the reflectance information registered in the memory unit 43, and transmits the identification result to the control unit 44.

The control unit 44 determines the operation content on the basis of the information obtained from the identification unit 42, and displays the information corresponding to the operation content on the information display face 12_{A} of the display unit 12. The operation flow after the control unit 44 confirms the operation which is being performed by the operator is, for example, the same as the flow shown in FIG. 5.

### 2-3. Example 3

In Examples 1 and 2, the case where the operator is the finger is exemplified, but the operator is not limited to the finger, and an arbitrary object may be used. In Example 3, a case of using a so-called 3-core ballpoint pen type operator (hereinafter, referred to as “ballpoint touch pen”) as the operator is described by way of example.

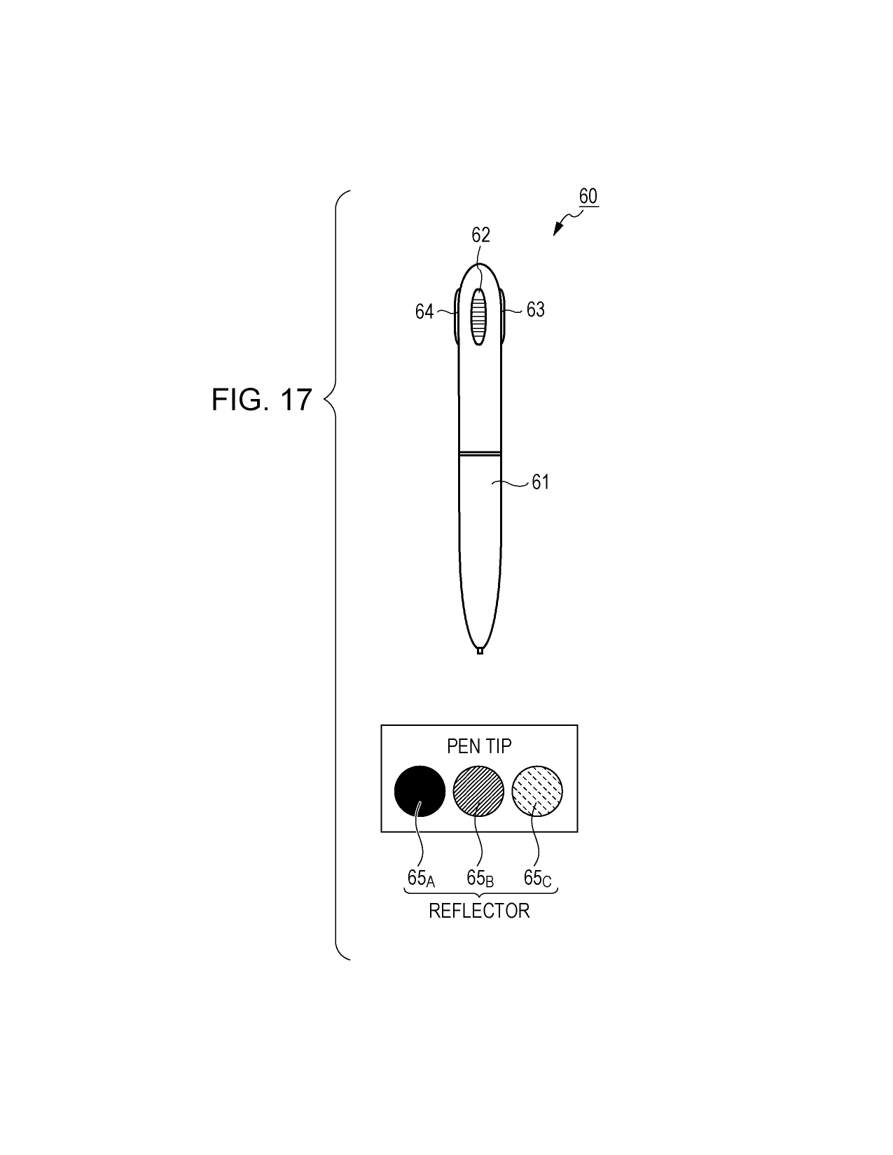

FIG. 17 is a front view illustrating an example of a configuration of the ballpoint touch pen according to Example 3. The ballpoint touch pen 60 has a hollow main body portion 61. In the main body portion 61, for example, three cores (not shown) housed movably along a longitudinal direction of the main body portion 61. Meanwhile, at the wall portion of circumference of the upper portion of the main body portion 61, three operators 62, 63, and 64 corresponding to three cores are mounted slidably along the longitudinal direction of the main body portion 61.

Each of three operators 62, 63, and 64 and each of the three cores have a configuration linkable by the mechanism of the related art. That is, when each of three operators 62, 63, and 64 is slid along the longitudinal direction of the main body portion 61, each of three cores is moved thereby along the longitudinal direction of the main body portion 61, and each tip portion protrudes from the tip end of the main body portion 61.

In addition, the tip ends (pen tip) of three cores are provided with reflectors (reflective substances) 65_{A}, 65_{B}, and 65_{c} with different reflectance, respectively. Herein, as an example, the reflectance of the reflector 65_{A} is 10%, the reflectance of the reflector 65_{B} is 30%, and the reflectance of the reflector 65_{c} is 50%.

Meanwhile, as the control system according to Example 3, for example, a control system with the same configuration (see FIG. 4) as that of the control system 40_{A} according to Example 1 may be used. In the memory unit 43 shown in FIG. 4, the operation content corresponding to each reflectance, that is, what operation is performed at each reflectance, is registered in advance in the memory unit 43.

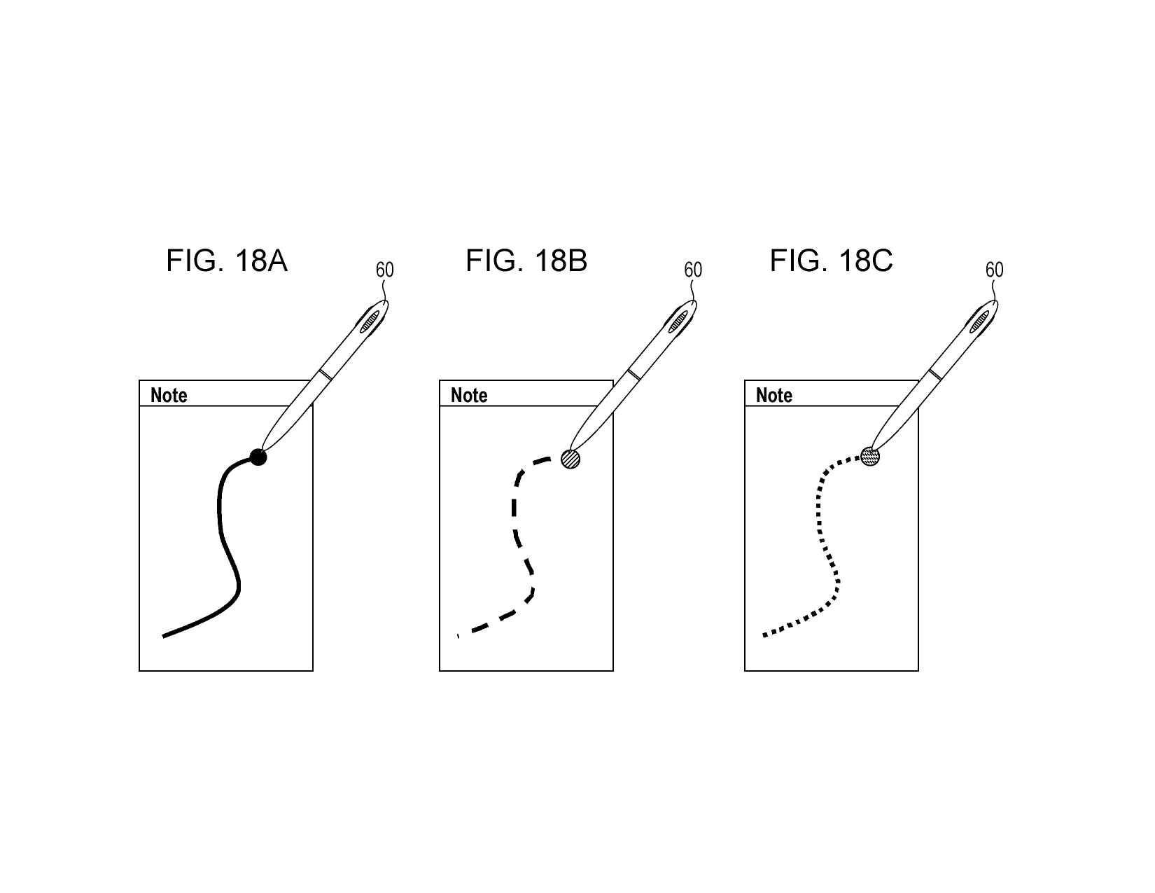

Specific examples of the operation contents for the display unit 12 are shown in FIG. 18A to FIG. 18C. For example, when the touch is performed with the pen tip of the reflectance of 10%, a black solid line is drawn. When the touch is performed with the pen tip of the reflectance of 30%, a black broken line is drawn. When the touch is performed with the pen tip of the reflectance of 50%, a red dot line is drawn. As described above, it is conceivable that the drawing control is performed on the information display face 12_{A} of the display unit 12.

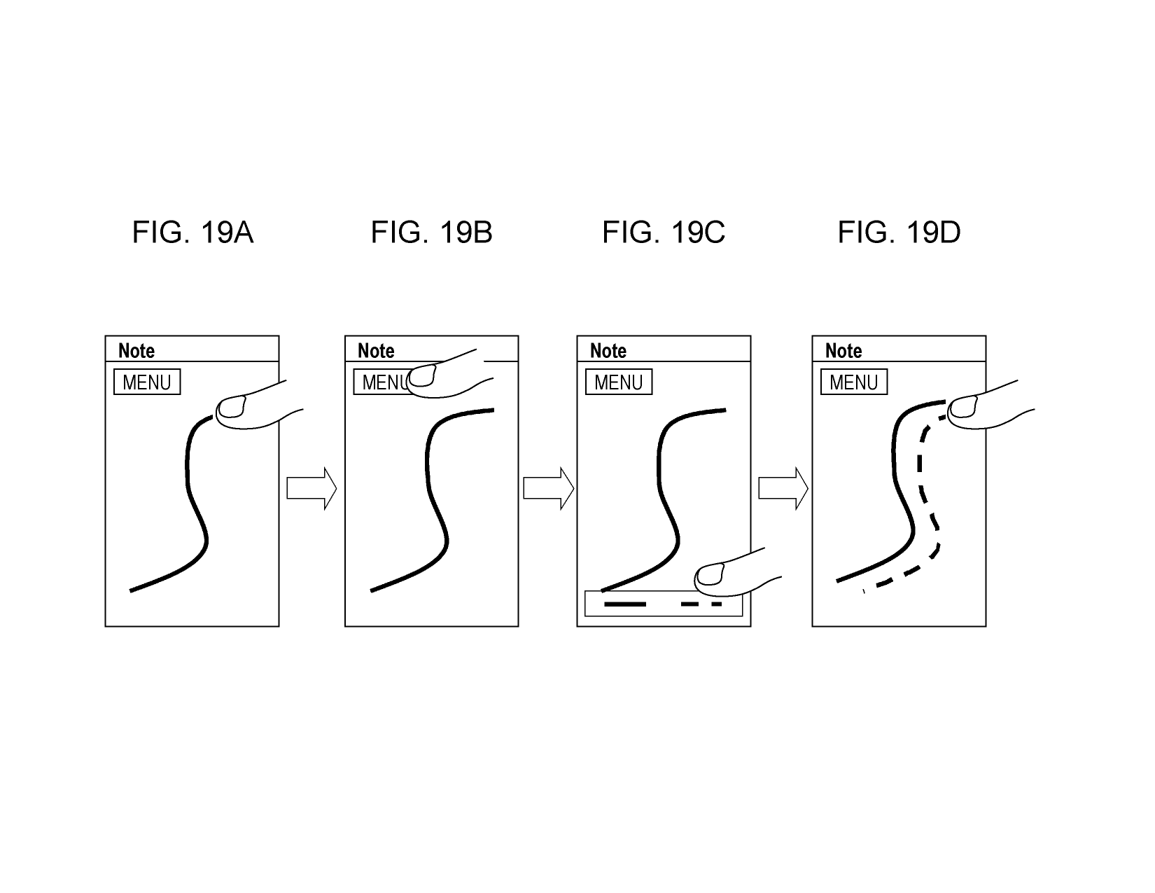

Herein, work examples in the touch panel type electronic apparatus of the related art will be described with reference to FIG. 19A to FIG. 19D. FIG. 19A to FIG. 19D show work examples when drawing S of a solid line and S of a broken line. In the related art, the solid line is drawn (FIG. 19A), then the “MENU” is touched to switch the solid line to a broken line (FIG. 19B), and a line kind selection screen is displayed on the information display face 12_{A}. Then, the broken line is selected on the line kind selection screen (FIG. 19C), and then the S line of the broken line is drawn (FIG. 19D).

As described above, in the related art, arbitrary drawing is realized by selecting a color or a kind of a line in the electronic apparatus and then, for example, drawing a line. However, the time is taken in the operation of selecting the kind of the line, it is different from the operation when a color line is drawn on the normal paper notebook, and thus the operation is not intuitive.

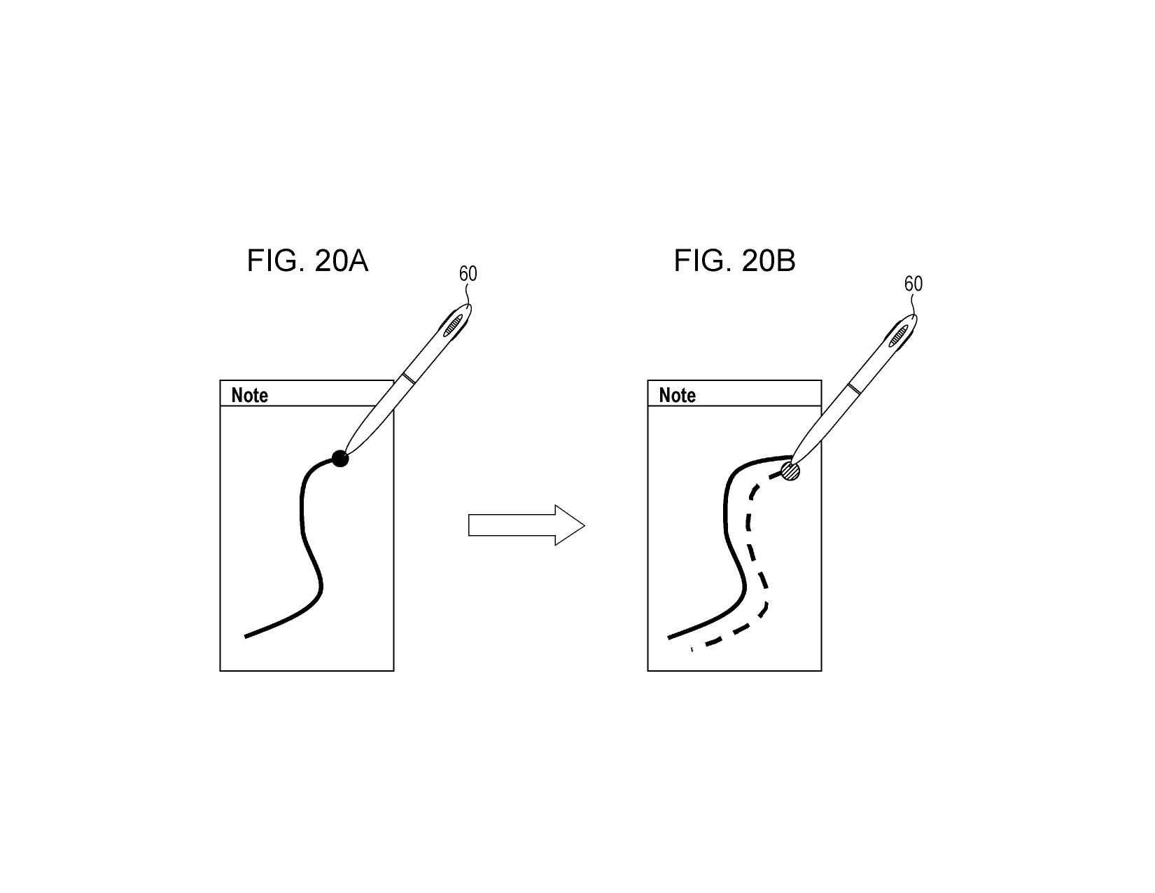

On the other hand, by performing the operation using the ballpoint touch pen 60 according to Example 3, the reflectance of the pen tip may be changed to the ballpoint pen type. Accordingly, as shown in FIG. 20A and FIG. 20B, the operation is completed by two of a work of drawing a solid line (FIG. 20A) and a work of drawing a broken line (FIG. 20B). Accordingly, it is possible to perform the intuitive operation of changing the reflectance of the pen tip such as drawing a line on the notebook of the related art.

### 2-4. Example 4

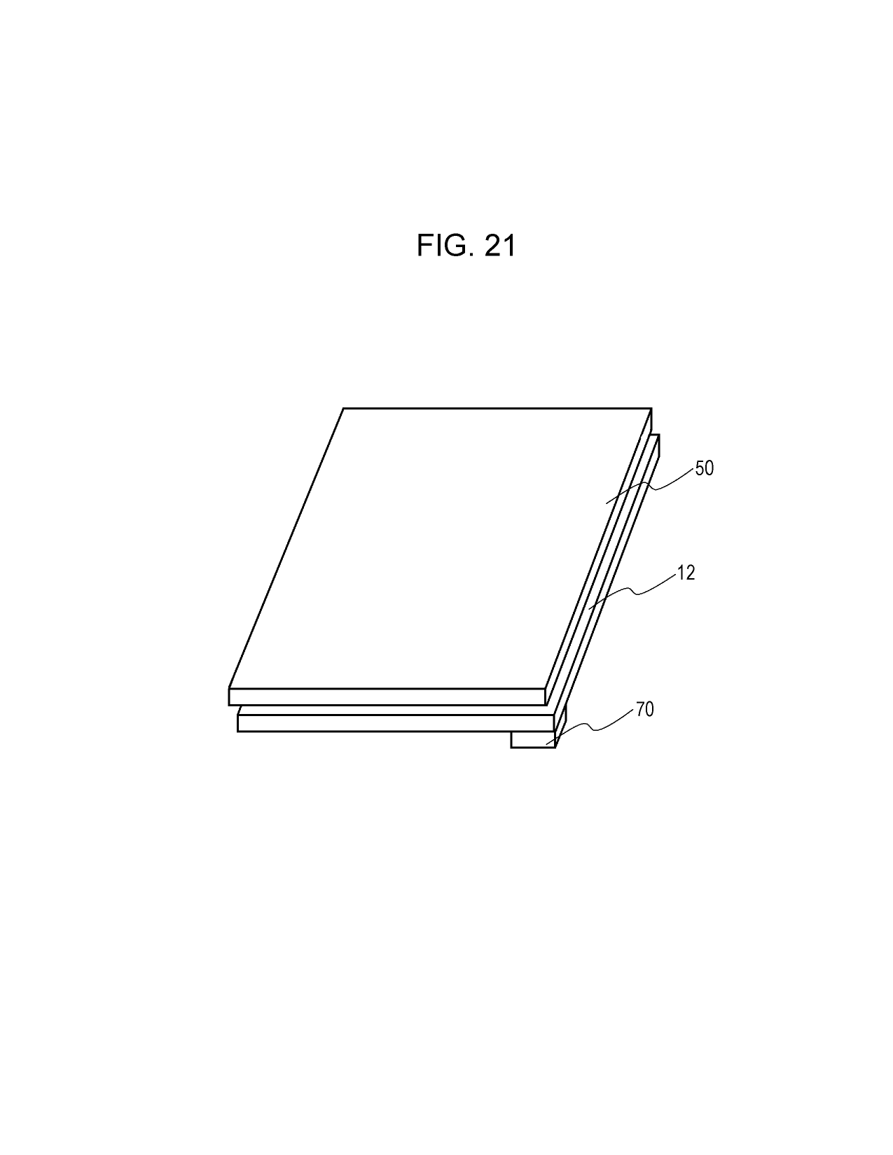

FIG. 21 is a schematic perspective view illustrating an example of a configuration around a display unit according to Example 4.

In Example 4, when the touch panel 50 is operated by the operator, a configuration in which a sound collector 70 such as a microphone that detects a sound transmitted through the display unit 12, that is, the organic EL panel provided with the photodiode 22 is commonly used is employed. It is preferable that the sound collector 70 be formed integrally with the organic EL panel to detect the sound transmitted through the organic EL panel when the touch panel 50 is operated by the operator.

When the touch panel 50 is operated by the operator, the sound collector 70 is used to identify the touch object by the sound when the operator comes in contact with the touch panel 50. When the operator is, for example, a finger and when the operation is performed with the nail part, a sound on the high frequency side is detected by the sound collector 70 as compared with the case of performing the operation with the skin part. When the operation is performed with the skin part, a sound on the low frequency side is collected by the sound collector 70 as compared with the case of performing the operation with the nail part.

Accordingly, when the touch panel 50 is operated, a frequency component of the sound detected by the sound collector 70 is read, the operation content registered in advance in the memory unit is referred based on the frequency component, and thus it is possible to identify whether the operator is the nail, the skin, or another substance. Specifically, in the flowchart shown in FIG. 5, the reflectance in the determination process of Steps S15 and S16 is transferred to the frequency component of the sound, and thus it is possible to perform the identification.

Herein, the memory unit that registers the operation content in advance corresponds to the memory unit 43 shown in FIG. 4. The memory unit registers the operation content corresponding to the frequency component of the detected sound in advance, that is, what operation is operated at each frequency component.

As described above, the identification of the kind of the operator based on the frequency component of the sound detected by the sound collector 70 is used commonly with the optical identification of Examples 1 to 3, and thus it is possible to further improve the precision of the identification of the kind of the operator.

### 2-5. Manufacturing Method

The display unit 12 according to the embodiment, that is, the organic EL panel provided with the photodiode 22 may be manufactured by an arbitrary manufacturing method.

### Example of Manufacturing Method

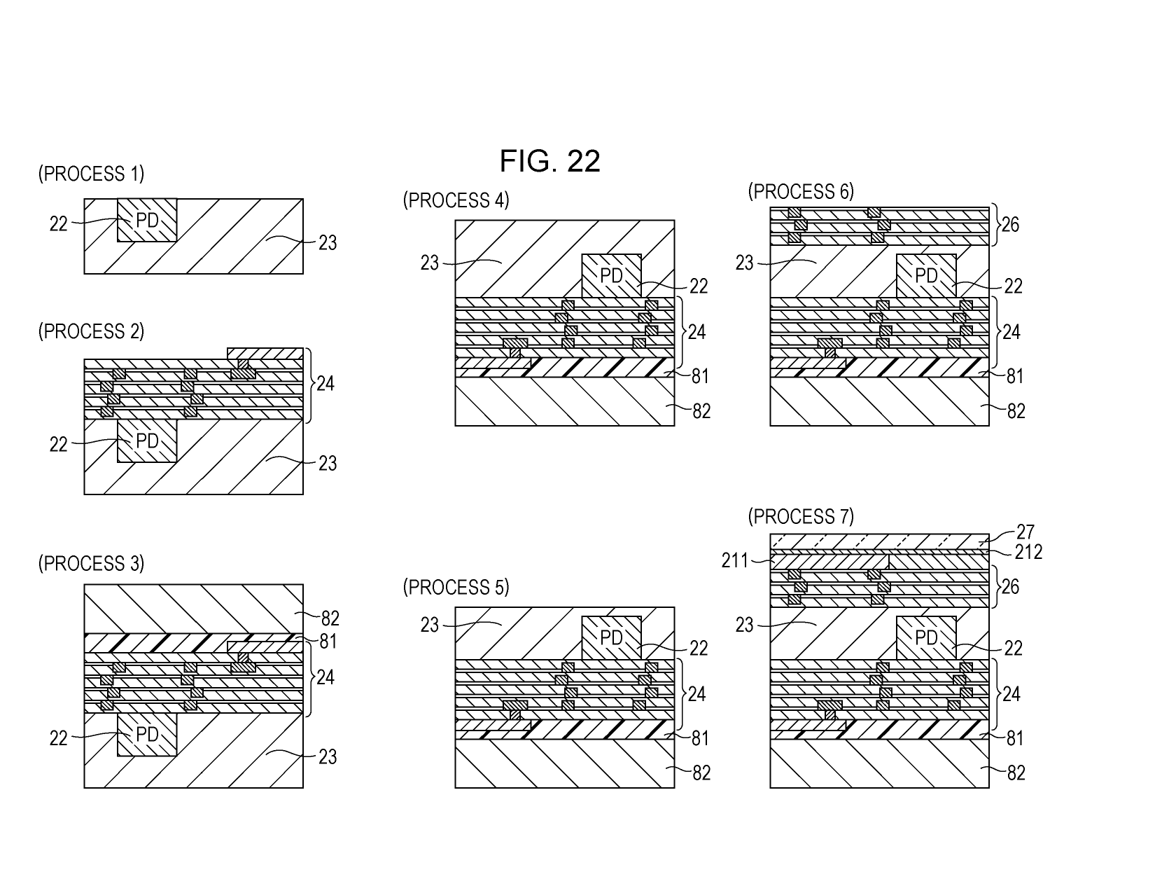

An example of the manufacturing method will be described with reference to a manufacturing processing diagram shown in FIG. 22. First, the photodiode 22 is manufactured on the semiconductor substrate 23 such as a silicon substrate using the method of the related art (Process 1). By concentration or energy of plastic that is ions in this case, the formation position of the photodiode 22 in the depth direction of the semiconductor substrate 23 may be arbitrarily determined.

Then, a transistor or connection wires (corresponding to the wiring layer 24 shown in FIG. 3) such that the photodiode 22 is driven to read a signal from the photodiode 22 is formed (Process 2). Then, a passivation film 81 is formed, a support substrate 82 is bonded (adhered) (Process 3), and then the semiconductor substrate 23 is reversed (Process 4).

Then, the back face side of the semiconductor substrate 23 is polished by back grinding, CMP (Chemical Mechanical Polishing), or the like, to be scraped off to the vicinity of the photodiode 22 (Process 5). By the process hitherto, portions related to the photodiode 22 are manufactured.

Then, transistors related to the driving of the organic EL elements 21 (21_{R}, 21_{G}, and 21_{R}) and connection wires (corresponding to the wiring layer 26 shown in FIG. 3) including the lower electrode of the organic EL element 21 are formed (Process 6), then the organic layer (the organic EL material) 211 of the organic EL element 21 and the upper electrode 212 are formed, and the protective film 27 is formed on the upper electrode 212 (Process 7). By a series of processes described above, as shown in FIG. 3, the upper side becomes the formation layer of the organic EL element 21, and the lower side becomes the formation layer of the photodiode 22.

In the case of the manufacturing method, the organic EL element 21 and the photodiode 22 are individually manufactured, and thus it is possible to apply an individually optimized process. Of course, not individually, they may be formed the same wiring layer or transistor layer.

As the photodiode 22, in the embodiment, the photodiode having the back face irradiation type sensor structure is used. Since the photodiode 22 is the photodiode having the back face irradiation type sensor structure, as clarified from the series of processes described above, there is an advantage that it is possible to manufacture the organic EL element 21 and the photodiode 22 by applying the individually optimized process.

The method of manufacturing the photodiode having the back face irradiation type sensor structure may be, for example, the manufacturing method of the related art disclosed in Japanese Unexamined Patent Application Publication No. 2011-138927. The method of manufacturing the organic EL element may be, for example, the manufacturing method of the related art disclosed in Japanese Unexamined Patent Application Publication No. 2006-338916.

Influence on Reflectance Measurement of Direct Light from Organic EL Element

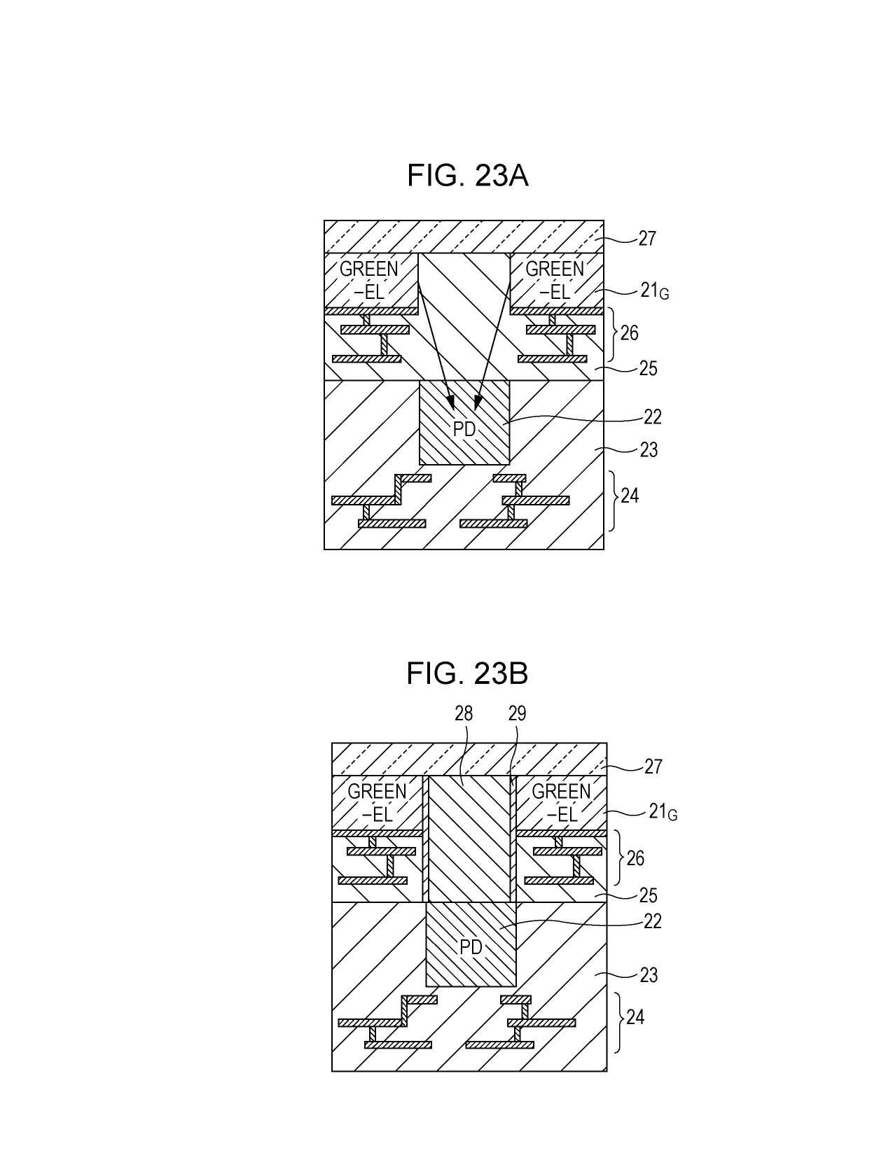

In the case of the structure of the display unit 12 shown in FIG. 3, as shown in FIG. 23A, it is assumed that the light emitted from the organic EL element 21 (21_{G}) is directly input to the photodiode 22 to cause disturbance in measuring the reflectance.

As shown in FIG. 23B, a light shielding wall 29 formed of metal or the like is formed to cover a position between the light propagation path 28 on the upper side of the photodiode 22 and the organic EL element 21 (21_{G}), preferably, the periphery of the light propagation path 28.

In such a manner, it is possible to block the light such that the direct light from the organic EL element 21 is not input to the photodiode 22, and thus it is possible to prevent the direct light from causing disturbance in measuring the reflectance in advance. The light shielding wall 29 is formed to cover the periphery of the light propagation path 28, and thus the mixed color is prevented from occurring by blocking the direct light from the organic EL elements 21_{R} and 21_{B} with different colors adjacent to the organic EL element 21_{G} as well as the direction light from the organic EL element 21_{G} with the photodiode 22 interposed therebetween.

### Another Example of Manufacturing Method

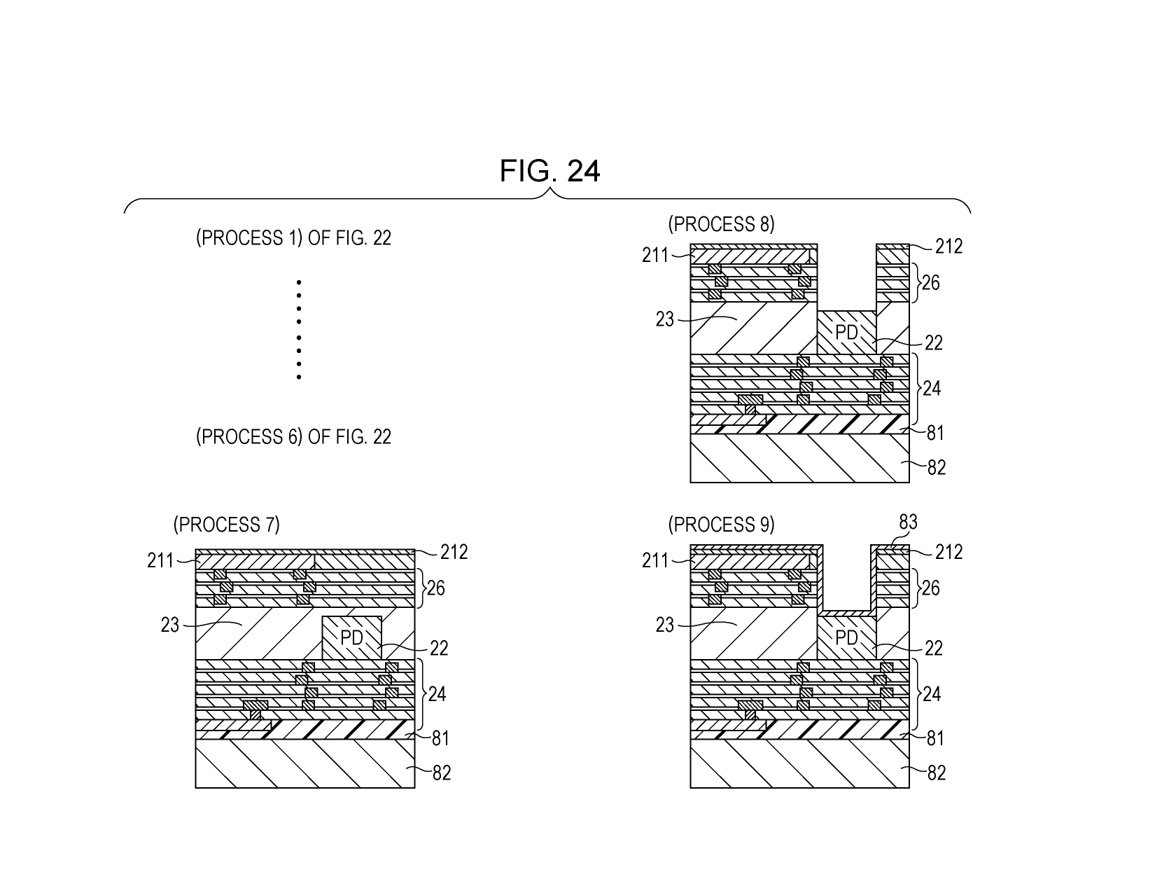

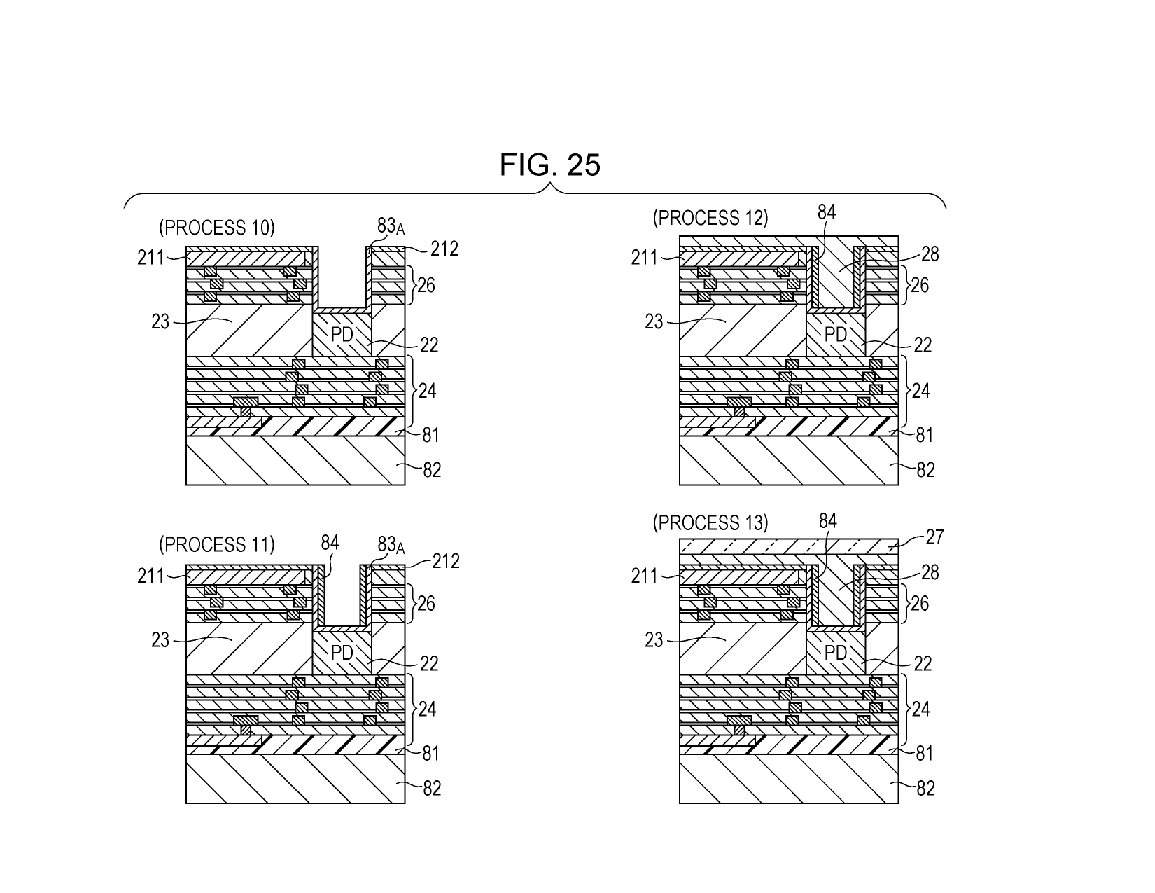

Another example of the manufacturing method with respect to the manufacturing method when forming the light shielding wall 29 as described above will be described with reference to manufacturing process diagrams shown in FIG. 24 and FIG. 25.

The processes to Process 6 described about the manufacturing process diagrams (see FIG. 22) of the manufacturing method described above are the same, and processes thereafter will be described hereinafter. First, in FIG. 24, the organic layer (the organic EL material) 211 of the organic EL element 21, and the upper electrode 212 are formed (Process 7), and then the upper side of the photodiode 22 is opened by dry etching (Process 8).

Then, a seed layer 83 for selectively growing metal is formed (Process 9). The seed layer 83 is, for example, a titanium nitride film or the like. As a method of forming a film, there is sputtering, chemical vapor deposition, atomic layer deposition, and the like.

Subsequently, in FIG. 25, the seed layer 83 other than the lateral wall is removed by etching (for example, reactive ion etching (RIE)), and only the seed layer 83_{A} at the lateral wall portion remains (Process 10). Then, aluminum is laminated only on the surface of the seed layer 83_{A} by selective CVD to form a metal light shielding film 84 (corresponding to the light shielding wall 29 shown in FIG. 23B) (Process 11).

The manufacturing method from the forming of the seed layer 83 to the forming of the metal light shielding film 84 may be, for example, the manufacturing method of the related art disclosed in Japanese Unexamined Patent Application

Then, resin or the like is applied to embed the light propagation path 28 and flattening is performed (Process 12), and then the protective film 27 is formed (Process 13). By the series of processes described above, as shown in FIG. 23B, the device structure having the light shielding wall 29 (the metal light shielding film 84) and preventing the light emitted from the organic EL element 21 from being directly input to the photodiode 22 by the light shielding wall 29 is completed.

### 3. Modification Example

In the embodiments, the reflectance or the sound is used to detect the kind of the operator, that is, the nail part, the skin part, the lateral face part, and the like when the operator is, for example, a finger, but there are various detection methods thereof, and the present disclosure is not limited to the reflectance and the sound. As another detection method, for example, a method of allowing small current to flow on the information display face 12_{A} of the display unit 12 to detect the kind of the operator according to the change of the small current may be exemplified.

In this detection method, when the operation is, for example, a finger, the resistance of the nail is higher than that of the skin, and thus the change amount of the small current is small. For example, by combination with Example 2, it is determined whether or not the touch panel 50 is touched with the finger, then it is determined whether or not the change of the small current is equal to or more than a predetermined threshold value, and thus it is possible to identify whether the kind of the operator is the nail or the skin. In this case, the threshold value may be registered in advance in the memory unit in a predetermined range similarly to the case of the reflectance, and the user may register the threshold value before using.

As described above, the identification of the kind of the operator based on the change of the small current flowing on the information display face 12_{A} of the display unit 12 is used together with the optical identification of Examples 1 to 3, and thus it is possible to further improve the precision of identification of the kind of the operation.

In addition, in the embodiment, the photodiode, particularly, the photodiode having the back face irradiation type sensor structure is used as the light receiving element, however the present disclosure is not limited thereto, and an element using, for example, a photoelectric convertible organic film may be used. As the element using the photoelectric convertible organic film, for example, an organic EL element used in a reverse bias state may be exemplified.

Accordingly, when the organic EL element is used as the light emitting element of the pixel, it is preferable to use the organic EL element even in the case of the light receiving element. In such a manner, it is possible to form both of the light emitting element and the light receiving element in the same wiring layer or transistor layer in the same process, and thus there is an advantage in reducing a manufacturing cost.

4. Configuration of Present Disclosure

The present disclosure may have the following configurations.

(1) An electronic apparatus including:

a display unit;

an identification unit that optically identifies a kind of an operator positioned on a display face of the display unit; and

a control unit that controls a content of an operation for the display unit according to the kind of the operator identified by the identification unit.

(2) The electronic apparatus according to the above (1), wherein the identification unit identifies the kind of the operator on the basis of light reflected from the operator.

(3) The electronic apparatus according to the above (2), wherein the identification unit calculates the reflectance of the operator on the basis of light quantity of irradiation of light emitted from a light emitting element provided in the display unit and light quantity of incidence of a light receiving element receiving the light emitted from the light emitting element and reflected from the operator and provided in the display unit, and identifies the kind of the operator on the basis of the calculated reflectance of the operator.

(4) The electronic apparatus according to the above (3), wherein the light emitting element is a light emitting element of a pixel of the display unit.

(5) The electronic apparatus according to the above (3), wherein the light emitting element emits light other than visible light.

(6) The electronic apparatus according to the above (4), wherein the light emitting element of the pixel is a self-emitting element.

(7) The electronic apparatus according to the above (6), wherein the self-emitting element is an organic electroluminescence element.

(8) The electronic apparatus according to the above (7), wherein the light receiving element is an element using a photoelectric convertible organic film.

(9) The electronic apparatus according to the above (4), wherein the light receiving element is provided corresponding to the pixel.

(10) The electronic apparatus according to the above (9), wherein the light receiving element is provided between the pixels with the same color.

(11) The electronic apparatus according to the above (9) or (10), wherein a periphery of a light propagation path to the light receiving element is covered by a light shielding wall.

(12) The electronic apparatus according to the above (3), wherein the light emitting element and the light receiving element are formed on the same semiconductor substrate.

(13) The electronic apparatus according to the above (3), wherein the light receiving element is a photodiode.

(14) The electronic apparatus according to any one of the above (3) and the above (9) to (13), wherein a color of the light receiving element is separated by a color filter disposed on the light receiving element.

(15) The electronic apparatus according to any one of the above (3) and the above (9) to (13), wherein a color of the light receiving element is separated by a formation position in a depth direction of a formed semiconductor substrate.

(16) The electronic apparatus according to any one of the above (1) to (15), further including a touch panel disposed on the display face of the display unit.

(17) The electronic apparatus according to the above (16), wherein the identification unit identifies the kind of the operator when the touch panel is operated by the operator.

(18) The electronic apparatus according to the above (16), further including a sound collector that detects a sound when the touch panel is operated by the operator, wherein the identification unit identifies the kind of the operator on the basis of a frequency component of the sound detected by the sound collector, in addition to the optical identification.

(19) The electronic apparatus according to the above (1), wherein the operator is a touch pen having a pen tip with different reflectance.

(20) A method of operating an electronic apparatus provided with a display unit, the method including:

optically identifying a kind of an operator positioned on a display face of the display unit; and

controlling a content of an operation for the display unit according to the identified kind of the operator.

The present disclosure contains subject matter related to that disclosed in Japanese Priority Patent Application JP 2011-265436 filed in the Japan Patent Office on Dec. 5, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An electronic apparatus comprising:
a display unit;
an identification unit that optically identifies a kind of an operator positioned on a display face of the display unit; and
a control unit that controls content of an operation for the display unit according to the kind of the operator identified by the identification unit.

2. The electronic apparatus according to claim 1, wherein the identification unit identifies the kind of the operator on the basis of light reflected from the operator.

3. The electronic apparatus according to claim 2, wherein the identification unit calculates the reflectance of the operator on the basis of light quantity of irradiation of light emitted from a light emitting element provided in the display unit and light quantity of incidence of a light receiving element receiving the light emitted from the light emitting element and reflected from the operator and provided in the display unit, and identifies the kind of the operator on the basis of the calculated reflectance of the operator.

4. The electronic apparatus according to claim 3, wherein the light emitting element is a light emitting element of a pixel of the display unit.

5. The electronic apparatus according to claim 3, wherein the light emitting element emits light other than visible light.

6. The electronic apparatus according to claim 4, wherein the light emitting element of the pixel is a self-emitting element.

7. The electronic apparatus according to claim 6, wherein the self-emitting element is an organic electroluminescence element.

8. The electronic apparatus according to claim 7, wherein the light receiving element is an element using a photoelectric convertible organic film.

9. The electronic apparatus according to claim 4, wherein the light receiving element is provided corresponding to the pixel.

10. The electronic apparatus according to claim 9, wherein the light receiving element is provided between the pixels with same color.

11. The electronic apparatus according to claim 9, wherein a periphery of a light propagation path to the light receiving element is covered by a light shielding wall.

12. The electronic apparatus according to claim 3, wherein the light emitting element and the light receiving element are formed on same semiconductor substrate.

13. The electronic apparatus according to claim 3, wherein the light receiving element is a photodiode.

14. The electronic apparatus according to claim 3, wherein a color of the light receiving element is separated by a color filter disposed on the light receiving element.

15. The electronic apparatus according to claim 3, wherein a color of the light receiving element is separated by a formation position in a depth direction of a formed semiconductor substrate.

16. The electronic apparatus according to claim 1, further comprising a touch panel disposed on the display face of the display unit.

17. The electronic apparatus according to claim 16, wherein the identification unit identifies the kind of the operator when the touch panel is operated by the operator.

18. The electronic apparatus according to claim 16, further comprising a sound collector that detects a sound when the touch panel is operated by the operator, wherein the identification unit identifies the kind of the operator on the basis of a frequency component of the sound detected by the sound collector, in addition to the optical identification.

19. The electronic apparatus according to claim 1, wherein the operator is a touch pen having a pen tip with different reflectance.

20. A method of operating an electronic apparatus provided with a display unit, the method comprising:
optically identifying a kind of an operator positioned on a display face of the display unit; and
controlling content of an operation for the display unit according to the identified kind of the operator.
